(19) United States
(12) Patent Application Publication
(10) Pub. No.: US 2026/0033552 A1
(43) Pub. Date: Feb. 5, 2026

(54) CAPSULE

(71) Applicant: AIR IP Holdings Limited, Dubai (AE)

(72) Inventors: Paul DAWSON, Dubai (AE); Jon STAFFORD, Caldecote (GB); Thomas BROWN, Caldecote (GB)

(21) Appl. No.: 18/879,577

(22) PCT Filed: Jun. 27, 2023
(86) PCT No.: PCT/IB2023/056638

§ 371 Date: Dec. 27, 2024

(30) Foreign Application Priority Data
Jun. 27, 2022 (GB) 2209401.5

(51) Int. Cl. A24F 40/53; A24F 1/30; A24F 40/42; A24F 40/51; A24F 40/57; A24F 40/65; G06K 7/10; H05B 1/02

(52) U.S. Cl. CPC A24F 40/53; A24F 1/30; A24F 40/42; A24F 40/51; A24F 40/57; A24F 40/65; G06K 7/10297; H05B 1/0252

(57) ABSTRACT

There is disclosed a capsule for use with an electronically heated/controlled shisha pipe, the capsule having a cavity containing a consumable product such as a vapourisable or combustible smoking product. A machine readable or interrogable indicator is provided on the capsule, the indicator provides data instructions for a transient heating profile of the consumable product, including a plurality of heating temperature values or power values and associated timings for said values. There is also disclosed an electronically heated water pipe having a heating chamber configured to receive the capsule and at least one sensor configured to electronically read or interrogate an indicator provided on the capsule to extract data instructions relating to a heating profile of the consumable product. The indicator may have a security code or token and the water pipe may prevent use of the capsule until the security code has ben validated.

The present disclosure relates to capsules containing a consumable material, particularly, but not limited to, capsules for use with electronic hookah devices.

### BACKGROUND OF THE INVENTION

Electronic shisha or hookah pipes provide a convenient means to smoke a shisha product. A prior art hookah device is shown in WO 2015/172224. The device is configured to heat a capsule containing a smoking product, for example, mu'assel or shisha. The capsule is received within a heating chamber in the device in order to vaporise and/or combust the smoking product, to produce aerosol which the user may inhale.

The inventor has found numerous problems with such prior art devices. Typically, such devices heat the capsule at a predetermined, fixed temperature. Such a temperature may be optimised for a standard composition of the smoking product.

If the composition of a given smoking product deviates from the standard composition, then the smoking experience may be sub-optimal. For example, if a smoking product comprises an ingredient configured to vaporised at a low temperature, then the heating the product at the standard temperature may result in burning of the product. Conversely, if an ingredient is configured to vaporised at a high temperature, then the standard temperature may produce a weakly flavoured smoking. Conventional devices thus limit the compositions which are suitable for use therewith and the use of non-standard capsules can present an adverse experience for the user.

The prior art capsule is configured to be substantially sealed. This retains the freshness of the ingredients. Once the smoking product has been depleted, the capsule is discarded. However, some users may refill the capsule with smoking product from a different source.

For example, this may be problematic in cafes or bars etc, as the capsule could be refilled with an inferior or less fresh smoking product than would otherwise be provided in a sealed capsule. This may result in an inferior smoking experience for the user, and/or the system may produce harmful compounds due to the incorrect or overheating of the smoking product.

The user may inadvertently heat an empty capsule and/or forget to deactivate the device once the smoking session has been completed. This may damage the device, create a fire risk or present adverse health risks to the user if they attempt to inhale from the device when a spent capsule is being heated.

It is an aim of the present invention to overcome or ameliorate one or more of the above problems.

### STATEMENT OF INVENTION

According to a first aspect of the invention, therefore is provided: a capsule for use with an electronically heated/controlled water pipe, the capsule comprising: a cavity having a consumable product therein; and a machine readable or interrogable indicator, the indicator comprising data instructions for a transient heating profile of the consumable product, the heating profile comprising a plurality of heating temperatures and associated timings for said heating temperatures.

The heating profile may comprise a plurality of individual data points relating to the different heating temperatures and respective times or time periods for said data points such that a point of application of said different heating temperatures is spaced in time.

Optionally, the data points are provided at a fixed interval. Optionally, the data points are only provided when a change in temperature of the heating profile is required. Optionally, the heating temperature remains constant between one or more sets of data points.

Optionally, the heating temperature changes with respect to time between data points (i.e. provides a temperature gradient). Optionally, the heating profile is smoothed between data points. Optionally, the controller is configured to heat the chamber using a PID method.

The heating profile may define a temperature at which the consumable product combusts or vaporises in use. The heating profile may define a desired or optimal vapourising/smoking temperature for the consumable product. The heating profile may vary for different consumable products, i.e. between different types of capsules of consumable product. The heating profile may define a curve/graph.

The indicator may comprise an electronically readable/interrogable memory device, and the heating profile date is stored on the memory device. The memory device may comprise re-writable memory. The indicator may comprise a wireless communication interface to provide reading/interrogation thereof. The heating profile data may be retrievable via the wireless communication interface. The communication interface may comprise RFID or NFC.

The consumable product may be held in a capsule. The capsule may comprise an outwardly extending rim, and the indicator is provided on or adjacent the rim. The capsule may comprise a first surface, a second surface and side wall provided between the first and second surface, and the rim extends outwardly from the first surface The rim may be provided adjacent an opening of the capsule. Optionally, a lid is attached to the rim. Optionally, the indicator is provided on the underside of the rim. Optionally, the indicator is provided on the upper side of the rim.

The first surface may comprise one or more aperture therein. A removable seal may be provided over the apertures and the indicator is provided on the removable seal. The capsule may comprise a closure or lid. The indicator may be provided on the closure/lid.

Optionally, the indicator is provided on or within a wall of the capsule. Optionally, the indicator is provided on or within a side wall, base, or closure of the capsule. Optionally. the indicator provided on an external portion of the capsule. The indicator may be contained within the capsule (e.g. within the cavity).

Optionally, the indicator is configured to change one or more of: transmitted wavelength; reflectivity; brightness; fluorescent properties; and/or transparency/opacity in response to a change in temperature thereof. Optionally, the indicator comprises a thermochromic pigment. Optionally, the thermochromic indicator is provided on one or more of the side wall, end wall, base, and/or closure.

The indicator may be removable/detachable from the capsule. The indicator may be provided on a carrier removably mounted to the capsule. The carrier may comprise a polymeric material. The carrier may comprise a collar, ring or sleeve configured to engage and at least partially surround the capsule. The carrier may comprise an outwardly extending tab, and the indicator may be provided on the tab. The indicator may be at least partially embedded within the carrier. The indicator may be removable/detachable from the carrier. The indicator may be mounted/fixed to a tray or plate received within the carrier. The tray/plate may be received with the tab. The tray/plate may slide out from the tab.

The indicator may comprise a machine-readable code (i.e. optically readable code). The machine-readable code may comprise one or more of: a barcode; a QR code; or 2-dimensional code. The machine-readable code may comprise a coloured portion or a plurality of coloured portions.

The indicator may comprise data indicative of one or more of: a batch number; manufacturing date/time; expiry date; use-by date; ingredients; allergens; and/or weight/volume of the consumable product.

The indicator may comprise a unique code or authentication token. Optionally, the unique code or token comprises a cipher. The indicator may selectively allow reading or interrogation thereof. The indicator may be only readable or interrogable if a predetermined code or authentication token or cipher is provided.

The indicator may comprise electronic memory. The memory may comprise a public memory portion. The memory may comprise a private memory portion. The private memory portion may only be accessible by via authentication (e.g. by provision of an authentication code or cipher). The heating profile data may be contained within the private memory portion. Additional/alternative data may be provided in the private portion.

The consumable product may be consumable by heating and/or may comprise a vapourisable product. The consumable product may comprise tobacco or a tobacco substitute, e.g. a shisha-based product.

According to a further aspect, there is provided: an electronically heated water pipe comprising: a heating chamber configured to receive a capsule comprising a cavity to contain a consumable product; and at least one sensor configured to electronically read or interrogate an indicator provided on the capsule and extract data instructions relating to a heating profile of the consumable product, the heating profile comprising a plurality of heating temperatures and associated timings for said heating temperatures; and a controller configured to control the temperature of the heating chamber in accordance with the heating profile.

The sensor may comprise a wireless communication interface. The wireless communication interface may comprise an NFC or RFID interface. The indicator may comprise one or electrical contact on an external portion thereof. The sensor may comprise an optical sensor.

The sensor may be provided on or adjacent the heating chamber. The heating chamber may comprise a first opening to receive the capsule, a second opening to receive a suction pipe, and a side wall extending between the first and second opening. A heater may be configured to heat the capsule in the heating chamber and may be mounted on or adjacent the side wall. The heating chamber may comprise an opening to receive the capsule, and the sensor is provided adjacent or proximal the opening.

The water pipe may comprise a closure configured to at least partially enclose the heating chamber, and the sensor is mounted on or within the closure.

The water pipe may be operatively connected to an intermediate computing device, and the sensor is provided on the intermediate device. The intermediate computing device may comprise a mobile computing device. The intermediate computing device may be configured to transmit heating profile data to the hookah device.

The water pipe may be configured to heat the indicator to a predetermined temperature to destroy or disable the indicator.

The controller may be devoid of machine-readable code for controlling a transient heating profile until the extracted data instructions relating to a heating profile of the consumable product are received from the capsule.

The controller may extract a unique code or token associated with the capsule. The controller may determine if the unique code or token corresponds to unique code or token provided in a predefined list of codes/token. The controller may selectively control heating of the heating chamber in accordance with said determination. The controller May selectively allow or deny heating. The controller may selectively deny heating if the unique code or token corresponds to unique code or token provided in a predefined list of codes/token.

Optionally, the predefined list comprises a list of unique codes or tokens of capsules that have been previously heated. Optionally the controller logs the extracted unique code or token in memory on the hookah pipe. The unique code or token may be a single use code/token. Optionally, the controller prevents heating of the heating chamber if the unique code or token corresponds to the unique code or token of a previously heated capsule.

Optionally, the hookah device comprises a memory device and the predefined list is stored in the memory device. Optionally, the predefined list is stored on a remote/intermediate device, and the hookah device comprises a communication interface configured to communicate with said device. Optionally, the hookah device communicates to the device via the internet. Optionally, the controller is configured to record the unique code or token during or after heating of the capsule in the heating chamber. Optionally, the controller is configured to record the unique code or token once the capsule has been heated to a predetermined temperature. Optionally, the unique code or token comprises cipher.

The controller may vary thermal or electrical power to the heating chamber in accordance with the heating profile.

Optionally, the water pipe comprises an inhalation sensor to detect inhalation of the user. The controller may monitor the sensor output. Optionally, the controller is configured to increase the temperature and/or increase heat input to the heating chamber in response to detection of inhalation. Optionally, the temperature/heat input is increased during the complete inhalation. Optionally, the temperature/heat input is increased for a fixed period of time.

Optionally, the water pipe comprises a sensor to detect is if a closure to the heating chamber is opened. Optionally, the controller is configured to reduce the temperature of the heating chamber and/or stop heating of the heating chamber in response to detection of opening of the closure. Optionally, the controller is configured to resume heating of the heating chamber in response to subsequent detection of the closing of the closure.

Optionally, the water pipe is configured to transmit a predetermined authentication code/token/cipher to the indicator.

The controller may selectively control heating of the heating chamber in accordance (i.e. prevent/allow heating thereof) with one or more of: detection that the capsule has been exposed to an undesirable temperature (e.g. by determining the colour of the thermochromic indicator); whether the consumable product is within/outside an expiration date; detection that the capsule is correctly located within the heating chamber (e.g. whether the indicator is properly readable/interrogable); determination that the type/size/weight of smoking product is suitable for use with the water pipe; determination that usage restrictions are satisfied (e.g. the age and/or ID of the user matches a predetermined value); and/or verification the data checksum on the capsule indicator data.

Optionally, the water pipe is configured to transmit a predetermined authentication code/token/cipher to the indicator (e.g. to access/authenticate the private memory portion).

The indicator may comprise a one or more executable code. The executable code may be extracted by the water pipe. The executable code may be executed by the water pipe.

The water pipe may comprise a hookah device or shisha pipe.

According to a further aspect of the invention there is provided: a method of controlling an electronically heated water pipe comprising: providing a heating chamber configured to receive a capsule comprising a cavity to contain a consumable product; and electronically reading or interrogating an indicator provided on or within the capsule and extracting data instructions relating to a heating profile of the consumable product, the heating profile comprising a plurality of heating temperatures for a respective a time or time period; and controlling the temperature of the heating chamber in accordance with the heating profile.

According to a further aspect of the invention there is provided: an electronically heated water pipe comprising: a heating chamber configured to receive a capsule comprising a cavity to contain a consumable product; and at least one sensor configured to electronically read or interrogate an indicator provided on or within the capsule and extract a unique code or token associated with the capsule; and a controller configured to determine if the unique code or token corresponds to unique code or token provided in a predefined list of codes/tokens.

According to a further aspect of the invention there is provided: a method of controlling an electronically heated water pipe comprising: providing a heating chamber configured to receive a capsule comprising a cavity to contain a consumable product; and electronically reading or interrogating an indicator provided on or within the capsule and extracting a unique code or token associated with the capsule; and determining if the unique code or token corresponds to unique code or token provided in a predefined list of codes/token.

According to a further aspect of the invention, there is provided: a capsule for use with an electronically controlled device comprising: a cavity to receive a human-consumbable product; and a machine readable or interrogable indicator, the indicator comprising data relating to the product. The product may be released by heating.

The indicator may comprise data instructions for a transient heating profile of the consumable product, the heating profile comprising a plurality of heating temperatures and associated timings for said heating temperatures.

Optionally, the consumable product comprises a smoking/vapourisable product for an electronic water pipe or hookah. Optionally, the consumable product comprises a hot beverage product. Where the beverage product comprises one or more of: tea; coffee; hot chocolate or products for preparation thereof.

An electronically heated consumable device may be provided comprising: a heating chamber configured to receive a capsule comprising a cavity to contain a human-consumable product: and at least one sensor configured to read or interrogate an indicator provided on or within the capsule and extract data relating to the consumable product.

The device may comprise a controller configured to extract data instructions relating to a heating profile of the product, the heating profile comprising a plurality of heating temperatures and associated timings for said heating temperatures; and the controller is configured to control the temperature of the heating chamber in accordance with the heating profile.

According to a further aspect, there is provided: a capsule for use with an electronic water pipe comprising: a cavity to receive a smoking product; and an indicator configured to change one or more visual property in response to a change in temperature thereof.

According to a further aspect there is provided a capsule for use with an electronic water pipe device comprising: a cavity to receive a consumable product; and an indicator comprising an electronic memory, the electronic memory comprising a public memory portion and a private memory portion.

The public memory portion may be accessible without authentication. The public memory portion may comprise one or more of: an ID or name/flavour ID for the capsule; a desired user intensity; an indication of consumption of the smoking product (e.g. time the capsule has been heated).

The public memory portion may be re-writable. The water pipe may write data to the public memory portion. The private portion may comprise one or more of: a security code or token; instructions for operation/heating of the water pipe; manufacturing data; and/or personal data (i.e. data that may be subject to privacy regulations).

According to a further aspect, there is provided an intermediate device for communication with a water pipe and/or capsule according to any preceding aspect, the intermediate device comprising: a reader for receiving capsule data; a writer for outputting data to the capsule and/or water pipe; and a user interface for user control of the output data, wherein the user interface allows user selection or alteration of a heating profile applied to the capsule by the water pipe.

Optional or essential features of any aspect of the invention may be combined with those of any other aspect of the invention where practicable.

### DETAILED DESCRIPTION

Workable embodiments of the invention are described in further detail below by way of example only, with reference to the accompanying drawings, of which:

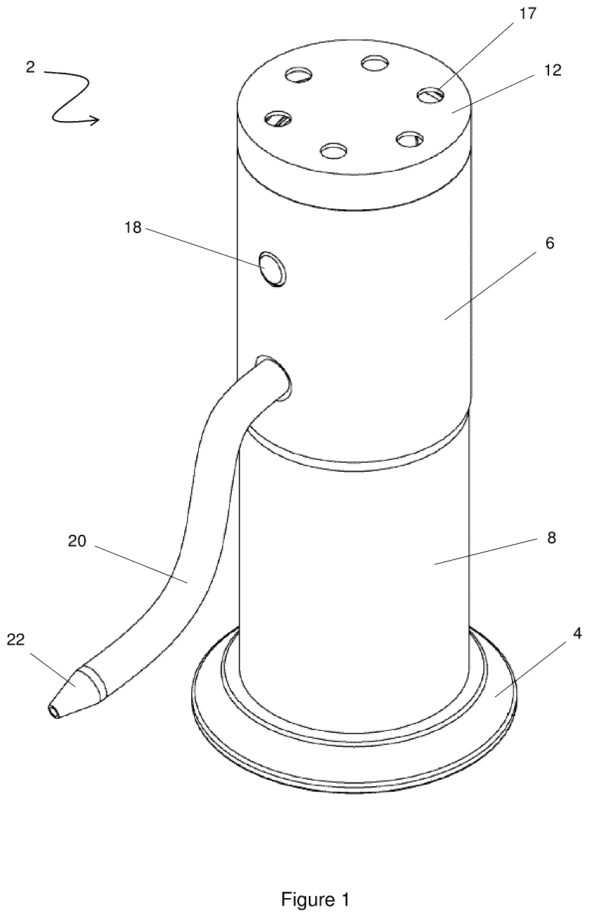

FIG. 1 shows a perspective view of an electrically heated shisha device;

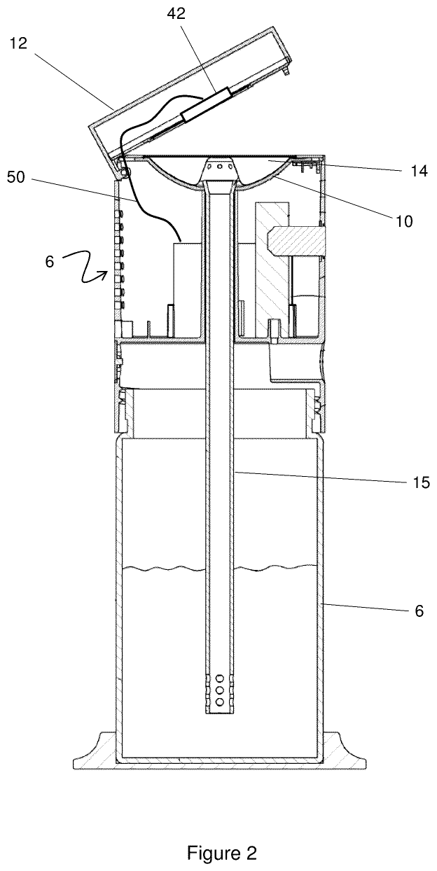

FIG. 2 shows a sectional side view of the electrically heated shisha device;

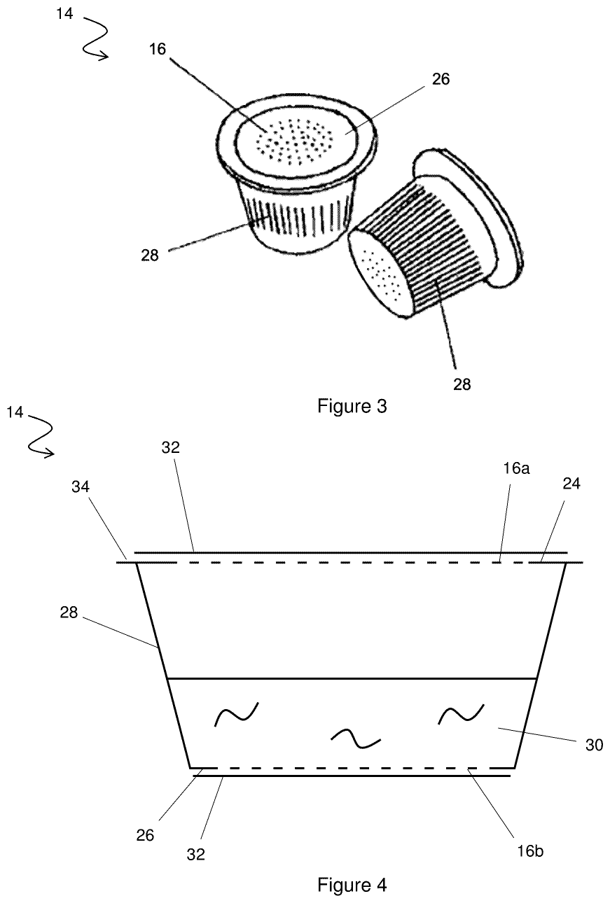

FIG. 3 shows a perspective view of a first capsule for use with the electrically heated shisha device;

FIG. 4 shows a sectional side view of the first capsule:

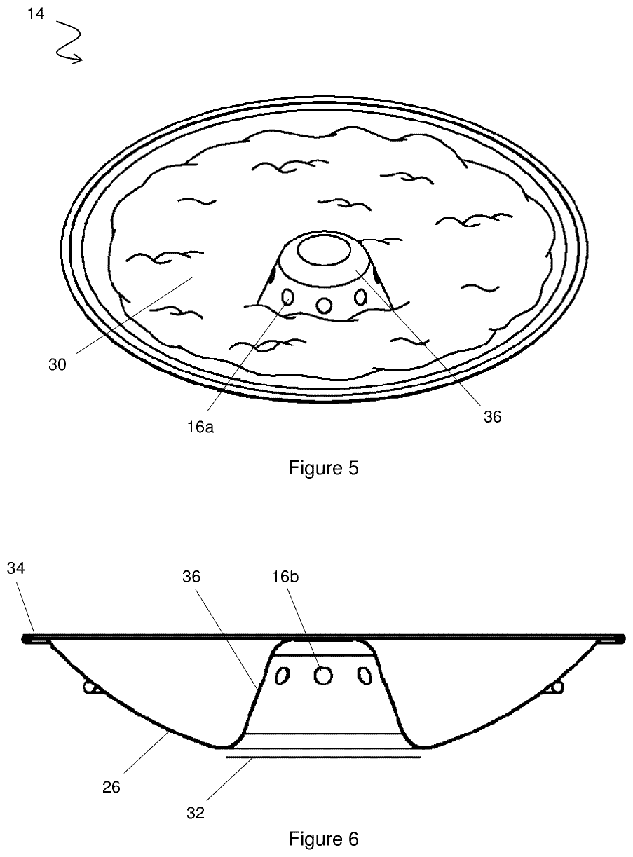

FIG. 5 shows a perspective view of a second capsule for use with the electronically heated shisha device;

FIG. 6 shows a sectional side view of the second capsule;

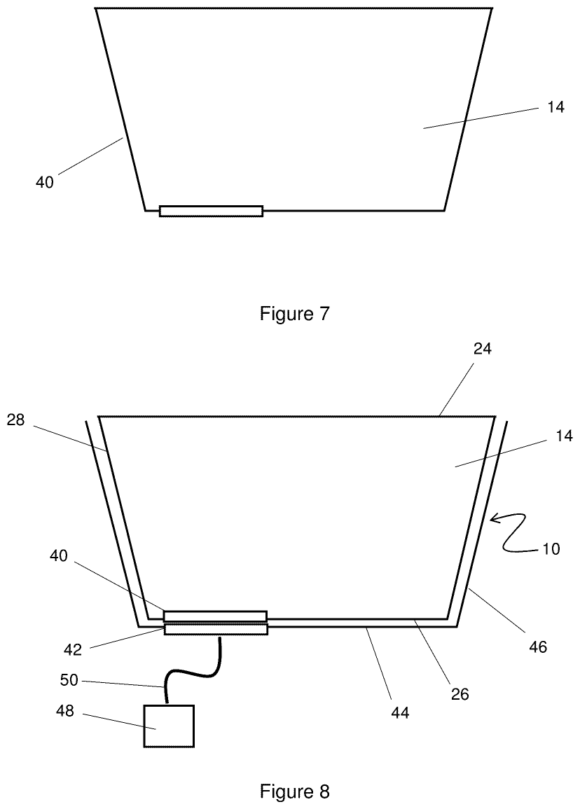

FIG. 7 shows a schematic side view of a capsule comprising a contact indicator;

FIG. 8 shows a schematic sectional view of a capsule comprising a contact indicator received with a heating chamber of the device;

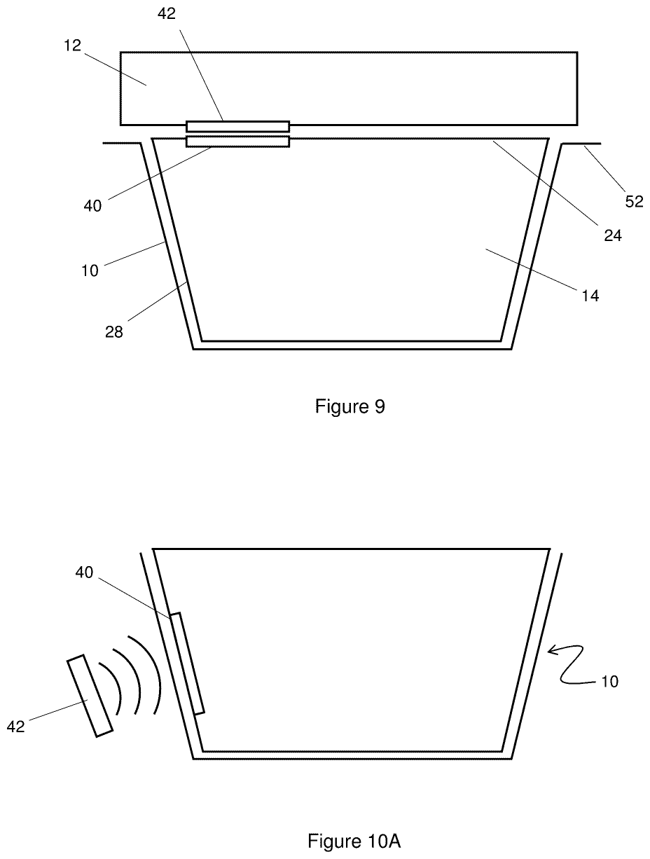

FIG. 9 shows a sectional side view of a further capsule embodiment comprising a contact indicator received with the heating chamber of the device;

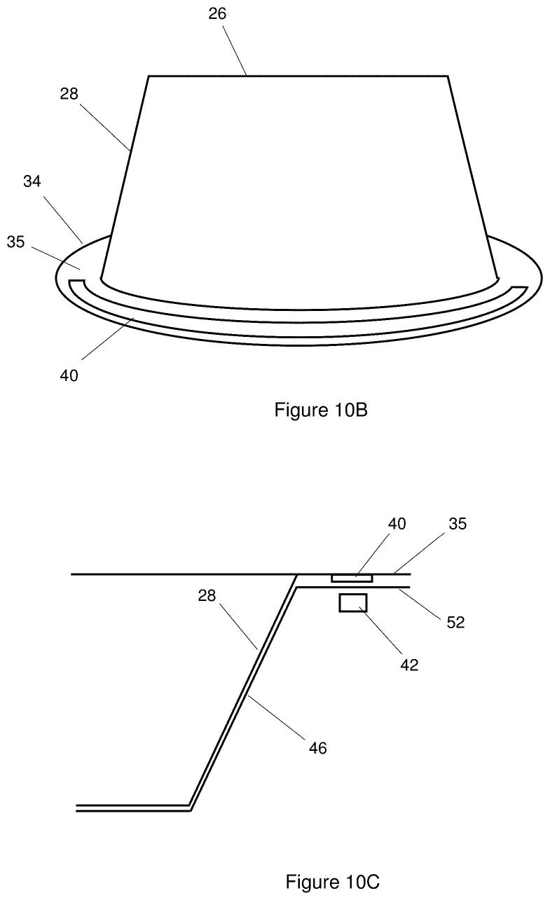

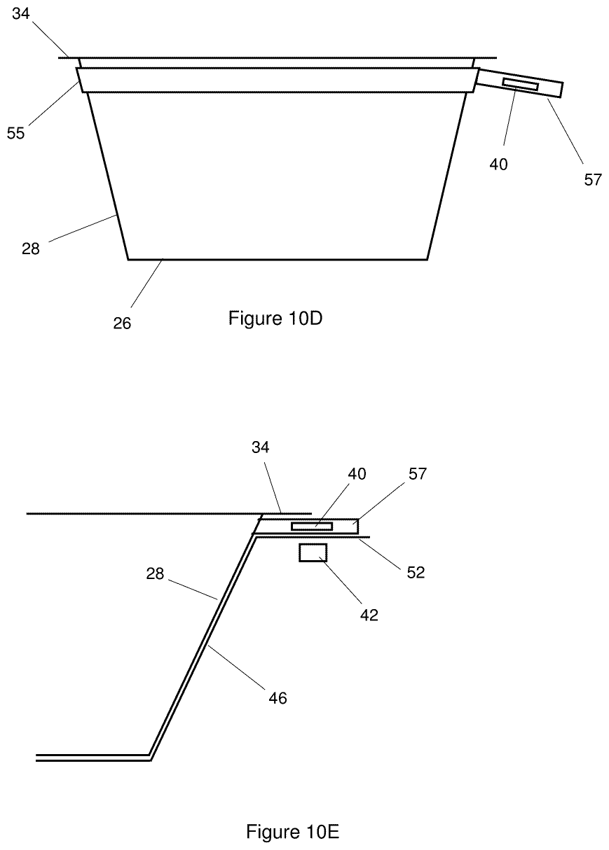

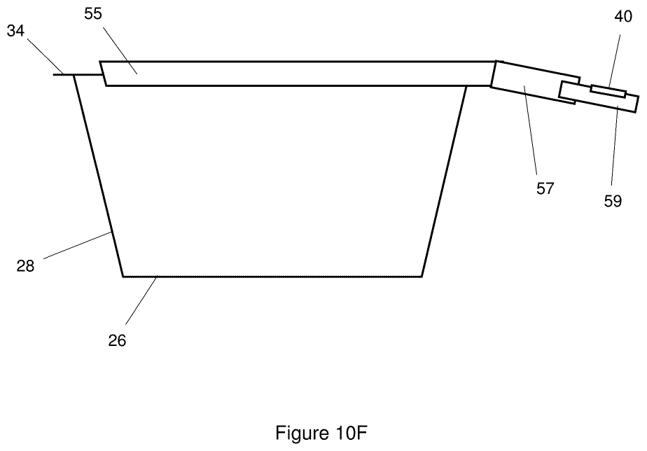

FIG. 10A shows a sectional side view of a capsule comprising a contactless indicator received with the heating chamber of the device;

FIG. 10B shows a perspective view of a second capsule comprising a contactless indicator;

FIG. 10C shows a sectional side view of a capsule comprising an indicator mounted via a carrier;

FIG. 10D shows a sectional side view of the capsule comprising an indicator mounted via a carrier;

FIG. 10E shows a sectional side view of the capsule comprising an indicator mounted via a carrier received with the heating chamber of the device;

FIG. 10F shows a sectional side view of the capsule comprising an indicator mounted via a carrier with a tray and/or collar formation;

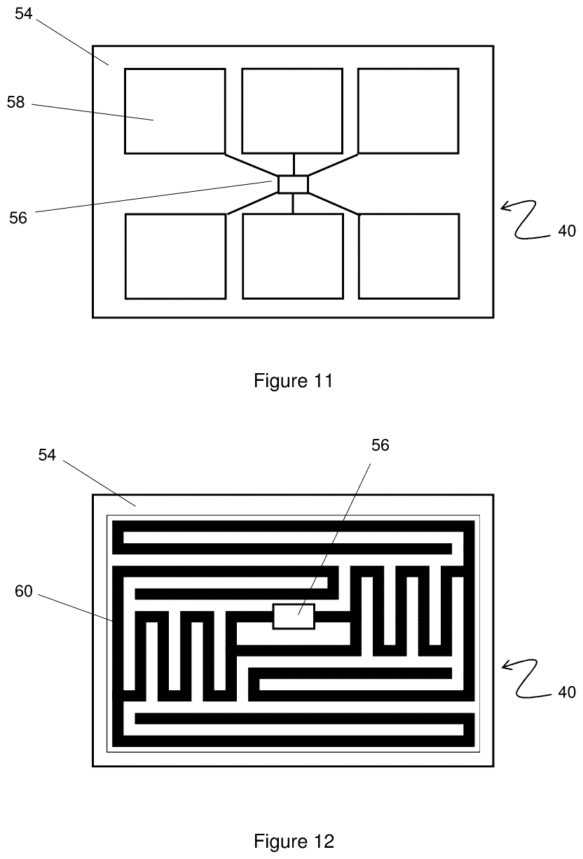

FIG. 11 shows a schematic view of the contact indicator;

FIG. 12 shows a schematic view of the contactless indicator;

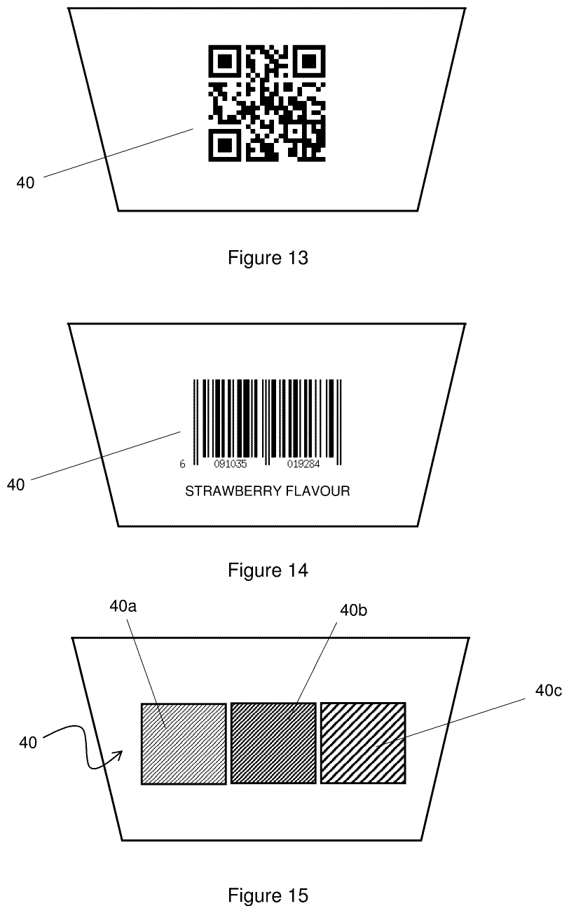

FIG. 13-15 show a schematic view of a capsule comprising respective coded indicators;

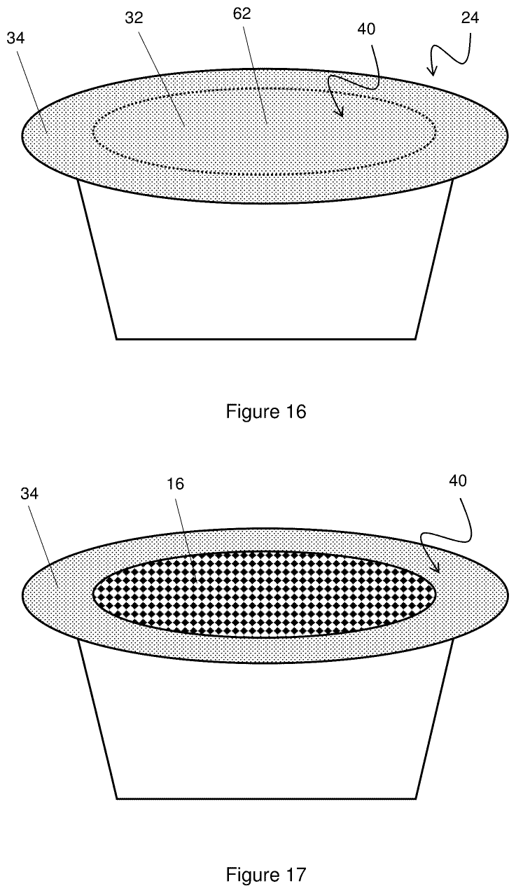

FIG. 16 shows a first perspective view of a capsule comprising a thermochromic indicator thereon;

FIG. 17 shows a second perspective view of the capsule comprising a thermochromic indicator thereon;

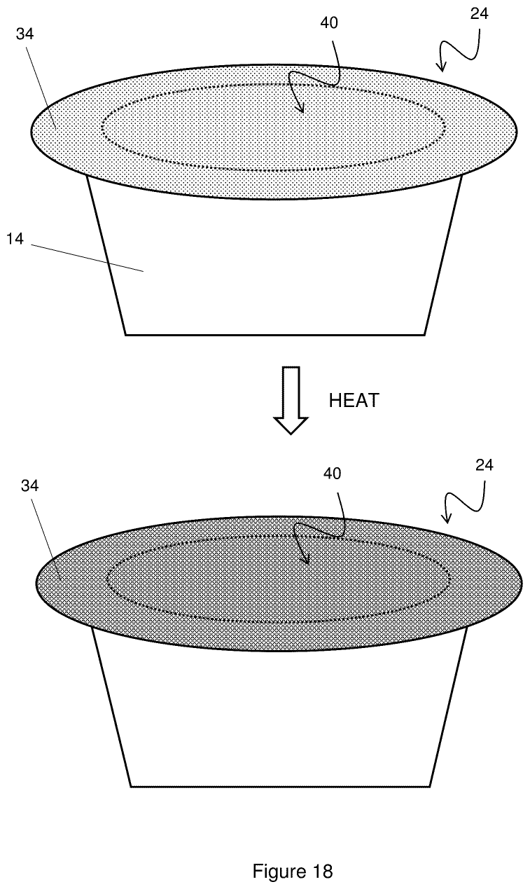

FIG. 18 shows a perspective view of a heating process of the capsule comprising a thermochromic indicator thereon;

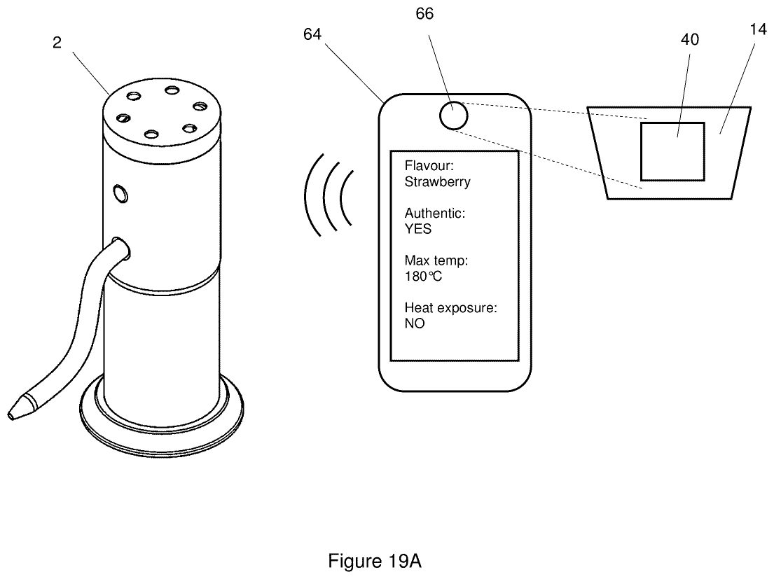

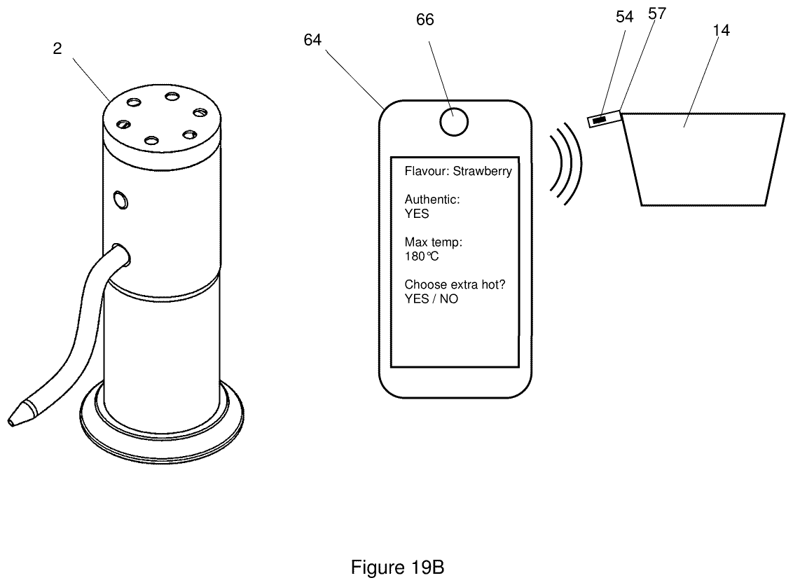

FIG. 19A shows a schematic view of an intermediate device for operatively/communicatively connecting to the shisha device;

FIG. 19B shows an alternative schematic view of an intermediate device for communicating to the capsule device,;

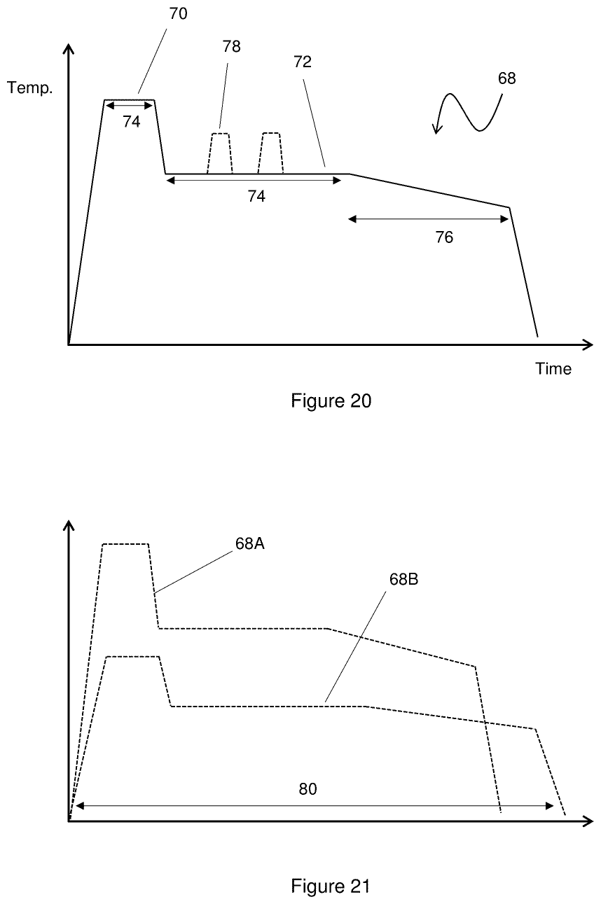

FIG. 20 shows a schematic view of a heating profile for the capsule;

FIG. 21 shows a schematic view of a modified heating profile for the capsule;

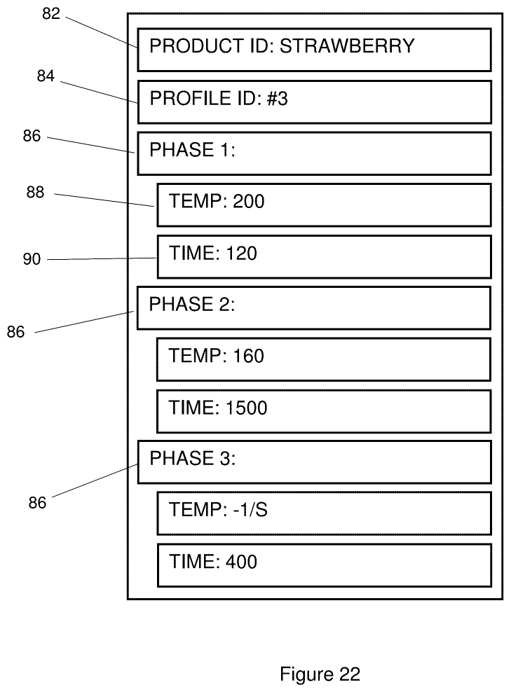

FIG. 22 shows a schematic view of a data structure for the heating profile;

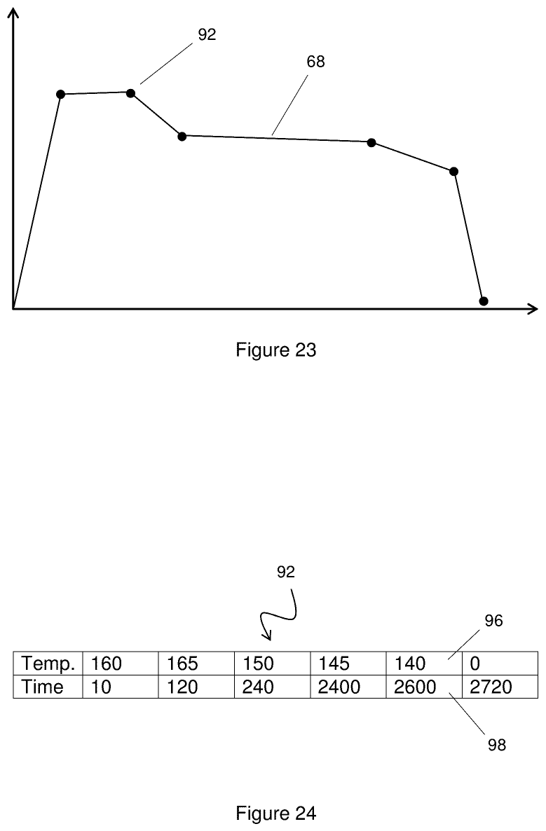

FIG. 23 shows a schematic view of a data sampling arrangement for the heating profile;

FIG. 24 shows a schematic view of a data structure for the data samples;

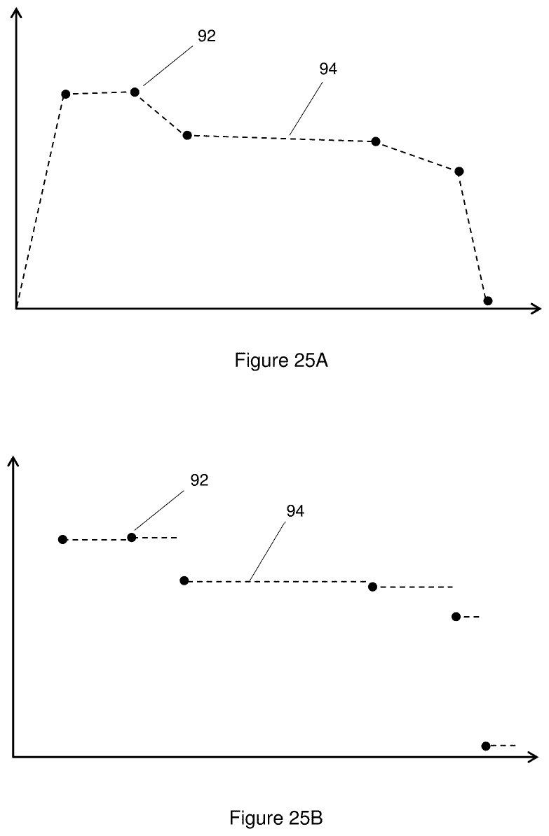

FIGS. 25A and 25B show schematic views of a reconstructed heating profile;

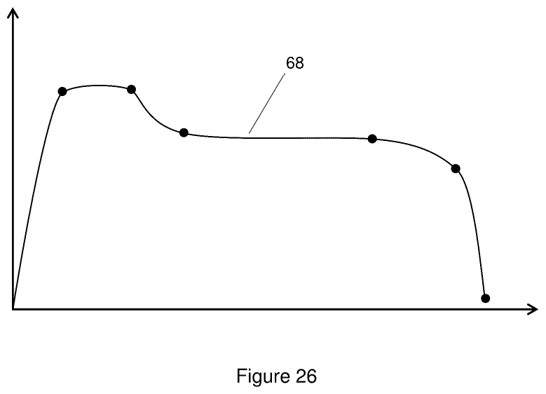

FIG. 26 shows a schematic view of a smoothed heating profile;

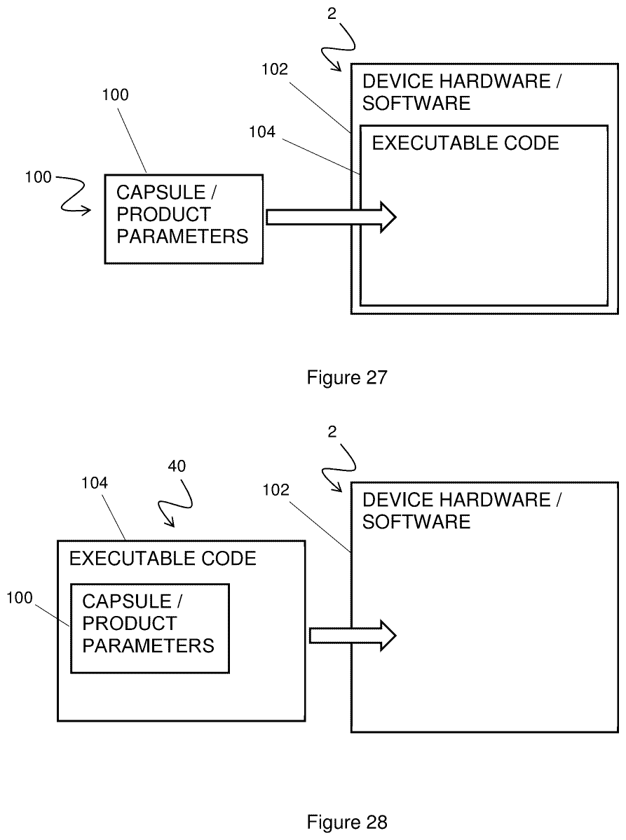

FIG. 27 shows a schematic view of a first data reading method;

FIG. 28 shows a schematic view of a second data reading method:

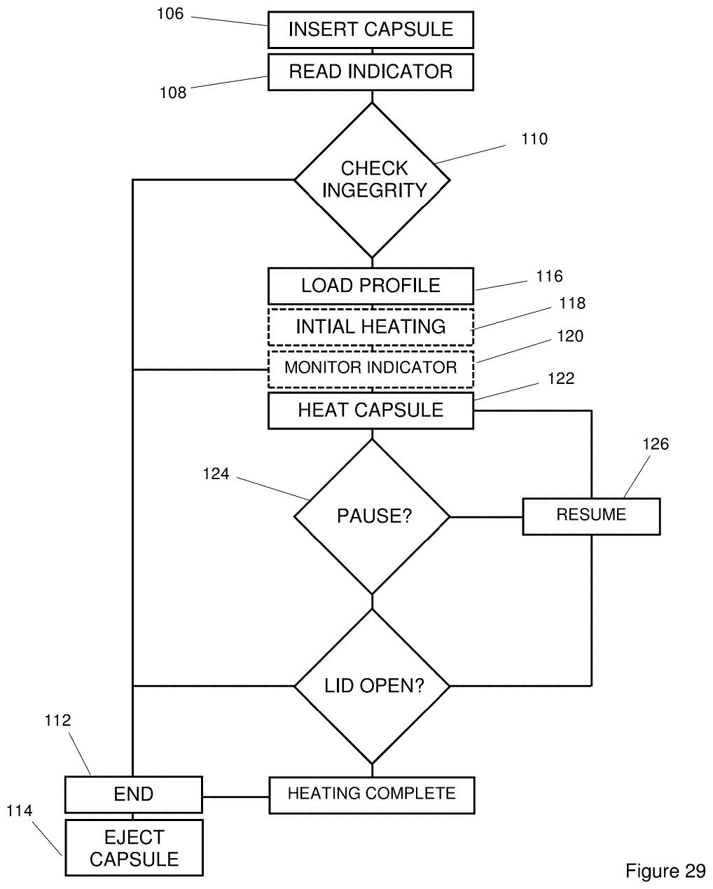

FIG. 29 shows a schematic view of a method of operating the shisha device;

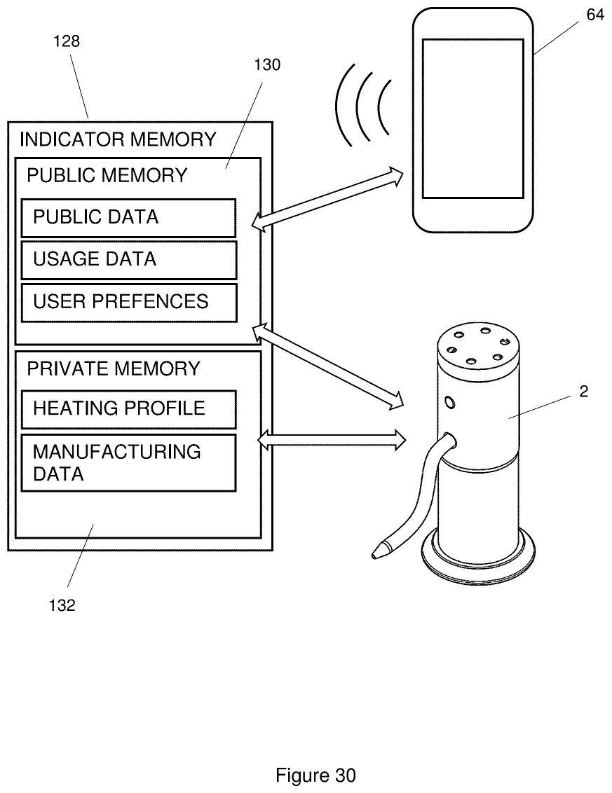

FIG. 30 shows a schematic view of a memory of the indicator.

FIG. 1 shows an example of a water pipe device 2, referred to herein as a hookah device or shisha pipe, although it will be appreciated that the pipe may be used for vaporising and inhaling a wide variety of consumable substances. The device 2 in this example is electrically heated and/or electronically controlled.

The water pipe device 2 comprises a base 4. The base 4 may provide a wide portion or area to prevent toppling of the device 2. An electronics compartment 6 is provided. The device 2 comprises a tank 8 configured to be filled with a liquid coolant (e.g. water). The tank 8 thus provides a container/reservoir. The electronic compartments 6 and tank 8 may be separatable/detachable. This allows access to an opening in the tank 8 for filling/emptying.

The electronics compartment 6 comprises a lid 12 to provide an opening thereto. As shown in FIG. 2, a heater 10 is mounted within the electronics compartment 6. The heater 10 is configured to receive a capsule 14 comprising a consumable/smoking product. The heater 10 heats the capsule 14 to vaporise or otherwise disperse one or more ingredient of consumable product. The heater 10 thus forms a heating chamber or container. One or more heating elements may be provided on, within and/or integral with the wall of the heating chamber 10. The heating chamber 10 comprises a thermally conductive material (e.g. metal). The capsule 14 forms a close fit with and/or engages the heating chamber 10. Thus, heat passes through the walls of the heating chamber 10 into the capsule 14 in use.

Typically, the heating elements comprise a resistive element (i.e. heated by electrical current flowing therethrough). However, any suitable means may be used to heat the heating chamber 10 and/or capsule 14, for example, one or more of: inductive heating; microwave heating; infrared heating; convective heating (e.g. the heating element is displaced away from the heating chamber 10 wall); electronically controlled combustion heating (e.g. using gas or other fuel); and/or oil heating. The heating chamber 10 comprises a thermally conductive material, for example, metal.

As best seen in FIG. 3, a plurality of apertures 16 are provided on the capsule 14 to allow the vaporised product to escape therefrom. The apertures 16 are typically less than 5 mm in diameter. Vaporised product enters the heating chamber 10 during heating of the capsule 14. The lid 12 and/or heating chamber 10 comprises one or more air inlet 17 to allow air into the heating chamber. This air then mixes with the vaporised product in the heating chamber 10.

The heater 10 may be controlled by electronics in the electronics compartment 6 (e.g. via a heater controller). The electronics may comprise a microcontroller/microprocessor; memory (volatile and/or non-volatile); and/or electrical regulation circuitry (e.g. power limiter and/or controller). The electronics compartment 6 comprises any suitable components to provide heating of the heater 10. A power supply is provided. The power supply may be mains powered. Additionally or alternatively, the power supply comprises a battery or the like. The battery may be removable and/or rechargeable. A power switch 18 may be provided. The device 2 and/or the heater 10 may therefore be manually activated/deactivated. Additionally or alternatively, the 10 heater may be activated/deactivated by means of an locking or closing mechanism configured to engage or secure the lid or other components of the heating chamber, thereby forming a safe enclosure around the heater in use. The heater may be inoperable when the lid is open or unlocked/unlatched.

The heating chamber 10 is operatively connected to the tank 8 via a conduit 15 passing through the electronics compartment 6. The vaporised smoking product therefore passes from the conduit 15 through the coolant in the tank 8 and is cooled and/or filtered therein. The conduit 15 passes through the electronics compartment 6. The conduit 15 is sealed from the electronic compartment 6 to prevent contamination thereof.

A suction hose 20 is provided in communication with a portion of the tank 8 above the coolant level. The suction hose comprises a mouthpiece 22. The mouthpiece 22 may be detachable/removable. Air can be drawn through the heated capsule and the vapourised product in the capsule can be carried by the airflow through the conduit 15. The user can therefore inhale to draw the vaporised product through the device 2 and out through the hose 20. Such a system emulates a conventional non-powered shisha/hookah pipe.

It can be appreciated that the device 2 shown in FIGS. 1 and 2 is merely exemplary and any suitable such device may be used. In some embodiments, the electronics compartment 6 may be provided below the coolant tank 8 such that the vaporised smoking product in use passes up through the device 2. The electronics compartment 6 may therefore form a base portion of the device 2. A conduit 15 may extend from the heater and up into the coolant to pass the vaporised product thereinto. A capsule 14 may be inserted into the base of the device 2.

Examples of suitable hookahs 2 and associated heaters 10 can be found in earlier published patent applications WO 2017/080545 A1 and WO 2015/172224 A1, the contents of which are incorporated herein by reference. Such details will not be repeated herein for brevity.

Referring to FIGS. 3 and 4, the capsule 14 comprises a top wall 24 and a bottom wall/base 26. The top wall 24 and the bottom wall 26 are connected via a side wall 28. The side wall 28 is substantially continuous. The top, bottom and side walls thus provide an enclosure/cavity for a smoking product 30. It can be appreciated that the term “top”, “bottom” and “side” are merely used to aid in description the capsule, and the capsule may be used in any suitable orientation in use.

A plurality of apertures 16a, 16b are provided in the top wall 24 and the bottom wall 26 respectively. During use, air passes through the apertures in the top wall 24 and into/through the smoking product 30. The smoking product 30 is heated and vaporised.

The air entrains the vaporised product in the capsule 14, and passes out from the apertures in the bottom wall 26. Such an arrangement provides a pre-packaged or prefilled capsule.

In some embodiments, apertures 16 may only be provided in one of the top walls 24 and bottom wall 26. Air thus enters and exits the capsule via the same apertures 16. In some embodiments, apertures 16 may be provided in the side walls 28. It can be appreciated any suitable arrangement may be provided to let the vapour egress from the capsule 14. However, the present arrangement is beneficial as it allows the capsule 14 to be heated via the side walls 28 and air to pass through the top/bottom of the capsule 14. This may help to ensure that air flow through the capsule 14 does not interfere with heating thereof.

In some embodiments, the device 2 is configured to puncture, perforate or otherwise open the capsule 14 to allow air enter/exit. The capsule 14 may therefore be sealed before opening. This may help to retain freshness. The top wall could be punctured by suitable formations in the lid 12 and/or bottom surface could be punctured by an end of the smoke conduit 15. Thus, the apertures need not be formed at the point of manufacture but could be formed during use of the capsule.

The capsule 14 may comprise a seal 32 to cover the apertures 16. The seal is removed before use to uncover the apertures 16. The seal 32 thus helps to retain freshness. A seal 32 may be provided on the top/bottom/side surfaces as appropriate. The seal may be attached to the capsule 14 using a peelable adhesive or the like. The seal 32 may comprise a pull tab of the like.

According to aspects of the invention, the entire capsule (either with or without a one or more seal 32 over the apertures 16) may be retained in a sealed pouch, package or sleeve so as to provide a retail article that can maintain the capsule in a fresh condition for extended periods of time. The pouch may be filled/flushed with an inert gas, such as nitrogen. Thus either or both of the capsule and pouch can be filled with a gas to help preserve the smoking product therein until use. Even if the capsule itself is air filled or unflushed, it has been found that flushing the pouch with a suitable gas can be sufficient, e.g. if the gas in the pouch and the air inside the capsule can mix such that the overall oxygen content within the pouch is low enough to promote a long capsule shelf life. The pouch may have a metallic/foil layer, e.g. as well as a polymer layer, if necessary.

The top surface 24 may comprise a closure (e.g. a lid). This allows the product 30 to be placed into the capsule 14. The apertures 16a may or may not be provided in the lid. The closure is then fixed to capsule to retain the product 30 therein. The closure may be fixed the upper edge of side wall 28. The side wall 28 may comprise an outwardly extending rim/flange 34. The closure may engage and be sealed to and/or deformed against the rim/flange 34. The lid 12 may engage the rim 34 and/or the closure attached thereto to form a seal therebetween. The rim 34 may be curled and/or comprise a strengthening element. The rim 34 may be planar and/or annular. The rim 34 may be parallel with the top surface 24 and/or lower surface 26.

The closure may be permanently fixed to the capsule 14 to prevent removal of the product 30 from therein. For example, the closure may be crimped or adhered onto the capsule 14. The closure may be crimped onto/over the rim 34.

In other embodiments, the closure may be releasably connected to the capsule 14, thereby allowing the user to access the interior of the capsule 14 (i.e. to refill the capsule 14). The closure may be connected to the capsule via a releasable connection means. The releasable connection means may comprise one or more of: an interference fit; a snap fit; a screw thread; a releasable latch or clip; a clamp; hook and loop; a press stud; a bayonet; or the like.

In the present embodiment, the bottom surface 26 is integrally formed with the capsule 14 (i.e. integral with the side wall 28). The apertures 16b are thus formed in the capsule 14. In alternative embodiments, the bottom surface 26 may comprise a permanent/removable closure.

The capsule 14 comprise a top wall 24 of greater area in plan than the bottom wall 26 such that the capsule is tapered/narrowed in form. The capsule 14 is tapered toward the bottom wall 26. This helps with release from the heating chamber 10. The capsule 14 is thus trapezoidal in cross-section (from a side view). The taper shown in the figures is merely illustrative, and the side wall 28 may be tapered at any suitable angle. For example, the side wall 28 may be tapered at between 1 and 45 degrees; preferably, between 1 and 30 degrees; preferably between 3 and 20 degrees. Typically, the side wall 28 is tapered by at least 1 degree, preferably by at least 3 degrees.

The capsule 14 comprises a circular profile (from a top view). The capsule 14 is thus frustoconical. However, it can be appreciated that the shape of capsule 14 is merely exemplary and the capsule may comprise any suitable shape for the intended purpose. Different shapes of capsule can be provided to achieve the desired contact with the interior of the device 2, e.g. a being shaped for good thermal contact with the heater 10. For example, capsules that are ovoid or polygonal in plan could be accommodated.

The capsules 14 are stackable. The upper and lower surface of the capsule 14 may comprise complementary recesses/protrusions to aid with stacking. For example, the base may have ridges/protrusions configured to engages a groove/recess on the upper surface 24 and/or rim 34 and vice versa.

Where the capsules 14 are stackable, a plurality of capsules may be simultaneously introduced into the heating chamber of the device in the same usage session. The capsules 14 may collectively define a substantially continuous fluid passage therethrough. This may provide a customised combination of active ingredients, compositions, and/or flavours to the user, depending on preferences.

The capsule 14 comprises a heat-resistant material. The capsule 14 is therefore stable at the heating temperatures of the device 2. The capsule 14 comprises a metallic material, for example, aluminium. The metallic material ensures adequate heat conduction into the capsule. In other embodiments, the capsule 14 may comprise a ceramic material. The capsule 14 may comprise a coating. The coating my comprise a coloured pigment or the like. The coating is temperature-stable (i.e. does not decompose at high temperatures).

A second embodiment of the capsule 14 is shown in FIGS. 5 and 6. The second embodiments may be substantially the same as the first embodiment, and like features will not be repeated. The lower wall 26 and the side wall 28 are continuous to form a curved base. The wall 26 curves inwards such that the capsule 14 is narrowed toward the lower end thereof.

The base/lower wall 26 of the capsule 14 comprises a recess 36. The recess 36 extends toward the upper edge of the capsule 14. The recess 36 therefore extends into the capsule 12. The recess 36 is curvate/arcuate. The base 26 of the capsule 12 is therefore domed. The recess 36 comprises a plurality of apertures 16b extending through the wall of the base 26. The apertures allow air/vapour to through the capsule 12 in use (i.e. to provide unidirectional airflow). In use, the smoking product 30 filled to a position below the recess apertures 16b, such that liquid or other smoking product does not flow therethrough. A removable seal 32 may extend across the recess 36. A further seal 32 may seal the upper end of the capsule 14.

Referring to FIGS. 7, the capsule 14 comprises an indicator 40. Generally speaking, the indicator 40 is configured to indicate or otherwise communicate one or more property of the capsule 14 and/or the contents thereof. In a specific embodiment, the indicator 40 indicates a specific formulation of the smoking product 30 and/or a heating profile thereof. The indicator 40 may therefore provide a label, tag, or the like. The contents of the indicator 40 will be described in detail later.

In a first embodiment, the indicator 40 comprises an electronic memory device. The indicator 40 and/or data therein may therefore be electronically read, downloaded and/or otherwise interrogated via a sensor 42 on the hookah device 2 (see FIG. 8). The memory device may comprise any suitable form. Typically, the memory device is non-volatile/persistent. Thus, data on the memory device is retained without the need for a power supply. The memory device may comprise EEPROM, Flash memory, or other suitable technologies. The memory may store at least 32 bits of data; preferably, at least 128 bits; preferably, at least 256 bits. The data may be stored either stored with or without encryption. The indicator comprises a memory controller to control the reading/writing of the memory and/or to control communication with the sensor 42.

In some examples, the memory device 56 comprises read-only memory (ROM). This prevents unauthorised tampering of the data on the indicator 40. Whilst the physical memory may be re-writeable, the indicator 40 itself and/or any external device (e.g. the hookah device 2) may be prevented from writing and/or re-writing data on the on the memory device 56.

In the embodiment shown in FIG. 8, the indicator 40 is configured to make physical contact with the sensor 42 on the device. This provides a “wired” or “contact” system. The indicator 40 is provided an exterior portion of the capsule 14 to allow contact with the device 2. The indicator 40 may be provided on the side wall 28, lower wall 26, and/or upper wall 24 of the capsule 14. Preferably, the indicator 40 is provided in the lower wall 26 as this prevents interference of the heat flow into the capsule 14 via the side wall 28 thereof. In some embodiments, the indicator 40 is provided on a portion of the capsule 14 outstanding from the therefrom, for example, the rim 34. The indicator 40 is therefore exterior to the heating chamber 10 in use.

The device sensor 42 is provided in a corresponding position to the indicator 40 to provide contact therewith in use. The sensor 42 is thus provided on/within the heating chamber 10. The sensor 42 may be provided on a lower end 44 and/or a side wall 46 of the heating chamber 10. The sensor 42 may be aligned with the indicator 40. The sensor 42 may be planar/parallel with the indicator 40.

In some embodiments, the sensor 42 is provided on the lid 12. The sensor 42 is thus provided on a movable closure for the heating chamber 10. The indicator 40 is provided on the upper surface 24 of the capsule 14 accordingly. This may prevent damage to the indicator 40, as the upper surface 24 is typically lower in temperature then the remaining portion of the capsule 14 in use. The indicator 40 may be provided off centre the capsule 14. For example, the indicator 40 is provided adjacent the side wall 28 of the capsule 14. This may reduce disruption/obstruction of the inlet apertures 16a. In other embodiments, the indicator 40/sensor 42 are provided in a centre of the capsule 14, such that the capsule 14 may be provided at any orientation. The sensor 42 may be operatively connected to the electronics compartment 6 via a cable 50 or the like (see FIG. 2).

Due to the high temperatures in the heating chamber 10, it can be appreciated the device or system 48 configured to read/interrogate the indicator may be displaced away from the sensor 42 to prevent damage thereto. As such, the sensor 42 may merely comprise an electrical one or more contacts or the like. The sensor 42 is then operatively connected to the sensor device 48 (e.g. via a cable 50 or the like). The contacts may be biased into engagement with the indicator 40. This improves electrical contact therewith. The contacts may be spring-mounted or spring-loaded. The contacts may be gold plated or the like. Where the indicator 40 is provided on the rim 34, the lid 12 may bias the sensor 42 into engagement with the indicator 40. For example, the indicator 40/sensor 42 are interposed the lid 12, a rim/outer edge 52 of the heating chamber 10.

In some embodiments, communication between the device 2 and the capsule 14 is wireless. This arrangement is shown in FIGS. 10A and 10B. The sensor 42 is therefore configured to communicated wirelessly with indicator 32. The sensor 42 comprises a wireless communication transmitter and/or receiver. The indicator 40 comprises a wireless communication transmitter and/or receiver accordingly. For example, the sensor 42 and/or the indicator 40 comprise an antenna or the like.

In some embodiments, the indicator 40 comprises a passive device. The indicator 40 does not comprise a dedicated power supply. The sensor 42 is configured is transmit a signal to the indicator 40 (i.e. an interrogating signal). The indicator 40 then uses the signal power to power the electronics within the indicator 40 and transmit a return signal. The sensor 42 then receives the return signal. This may provide an RFID system or the like. This allows the indicator 40 to be low cost and simple construction.

The sensor 42 may be configured to transmit an interrogation signal at predetermined intervals (e.g. when the system is powered). This allows the sensor 42 to detect when a capsule 14 is received within the device. Typically, the interval is between 0.1 seconds and 1 second. In other embodiments, the interrogation signal is provided via manual input by the user. For example, the user may push a button to activate the interrogation signal. The sensor 42 may then transmit a predetermined number of interrogation signals; repeatedly transmit the interrogation signal for a predetermined time period; and/or repeatedly transmit the interrogation signal until the user releases/deactivates the manual input.

In other embodiments, the indicator 40 comprises an active device. The indicator 40 thus comprises a dedicated power supply (e.g. a battery). The indicator 40 is configured to transmit a signal. The signal may comprise an identification signal or handshake or like. The signal is then received by the sensor 42. The sensor 42 may then transmit and acknowledgement signal. The indicator 40 may then transmit the data contained therein. In other embodiments, the indicator 40 may merely transmit the data without the handshake arrangement (e.g. broadcasts the signal).

The wireless communication may use any suitable radio frequency, for example: LF; HF; UHF and/or microwave frequencies. The wireless communication is typically short range, for example, less than 100 cm; preferably, less than 50 cm; preferably, less than 5 cm. For example, the system may use Near Field Communication (NFC). This ensures the correct capsule is interrogated by the sensor 42 and/or reduces power consumption. The power of the wireless communication system may be less than 1 W.

It can be appreciated the wireless sensor 42 and/or any associated read device 48 is positioned on/within in any suitable position to read the indicator 40. The sensor 42 may be provided proximal or adjacent the heating chamber 10 and/or within the lid 12. The sensor 42 may be displaced away from the heating chamber 10 (i.e. the surface thereof) and/or capsule 14. Typically, the sensor 42 is contained within the electronics compartment 6. The heating chamber 10 may be configured to allow wireless transmission through. For example, the heating chamber 10 may comprise an aperture or non-conductive (e.g. ceramic) portion to allow transmission therethrough.

Accordingly, the wireless indicator 40 may be provided in any suitable position on/within the capsule 14. Typically, the indicator 40 is provided on an external portion of the capsule 14 (e.g. the lower wall 26, upper wall 24, or side wall 28). This allows easier wireless transmission. In alternate examples, the indicator 40 is contained within the capsule 14. The indicator 40 may be affixed to an internal side of the capsule wall, within an internal compartment thereof, or loosely contained therein.

In the specific embodiment shown in FIG. 10B, the indicator 40 is provided on the rim 34 of the capsule 14. The indicator 40 may be provided on the underside 35A of the rim 34 (i.e. the side facing toward the side walls 28 and/or lower wall). Additionally or alternatively, the indicator 40 is provided on the upper side. The indicator 40 may be fully or partially embedded within the rim 34. For example, the indicator 40 may be flush with the surface of the rim 34. The indicator 40 may extend around the perimeter or circumference of the rim 34. The indicator 40 may therefore be arcuate, angled or otherwise convex/curved. The indicator 40 may extend partially or completely around the rim 34.

As shown in FIG. 10C, the sensor 42 is provided in a position to read the indicator 40 accordingly. The sensor 42 is provided adjacent the heating chamber 10. The sensor 42 is provided on or adjacent the shoulder/rim/outer edge 52 of the heating chamber 10. Alternatively, the sensor 42 is provided on/within the lid 12. The indicator 40 and/or sensor 42 are therefore removed from the heating zone of the capsule 14 and/or the smoke path.

This may help to prevent contamination thereof from particulate matter in the vaporised smoking product and/or heat damaged to the sensor 42.

The indicator 40 comprises a thickness that ensures the walls 28 of the capsule 14 maintain contact with the walls 46 of the heating chamber 10. Similarly, the thickness is such that the rim 34 may lie flat against the rim 52 of the heating chamber. The indicator 40 comprises a thickness of less than or equal to 1 mm, preferably, less than or equal to 0.5 mm.

Referring to FIG. 10D, the indicator 40 may be attached to a carrier 55. The carrier is mounted to the side walls 28 of the capsule 14. The carrier 55 may therefore be mounted circumferentially. The carrier 55 may be provided adjacent or in abutment with the capsule rim 34. The carrier 55 generally surrounds the capsule 14. The carrier 55 is therefore annular or ring shaped. The carrier 55 may provide a collar, band or sleeve. In some embodiments, the carrier 55 may partially surround the capsule 55 (e.g. the carrier 55 is crescent or C-shaped).

The carrier 55 is polymeric. The carrier 55 may comprise any suitable polymer. The carrier may comprise a high-temperature thermoplastic. This prevents combustion or decomposition thereof during heating. The carrier 55 may comprise one or more of: Polyphenylene sulphide (PPS); Polyethersulfone (PESU); Polyphthalamide (PPA); Polyphenylsulfone (PPSU); Polyurethanes; Silicones; and combinations thereof. The polymers generally comprise at least one aromatic functional group.

The carrier 55 is removable/separable from the capsule 14. This allows separate recycling/disposal of the carrier 55 and the capsule 14. The carrier 55 may form an interference fit/friction fit. The carrier 55 is therefore loosely held in place on the capsule 14 (i.e. is not permanently fixed thereto). The carrier 55 is sized to provide a close/tight fit with the capsule. This allows easy removal thereof. In other embodiments, the carrier 55 is permanently fixed to the capsule 14, for example, using adhesive, fasteners or the like.

In some embodiments, the indicator 40 is provided on a tab 57 on the carrier. The tab 57 provides a flap, lip or projection extending outwardly the carrier 57. The tab 57 extends outwardly is substantially the same direction as the rim 34 of the capsule 14. The tab 57 is therefore provide adjacent or in abutment with the rim 34. The tab 57 projects away from the capsule side wall 28 thereby preventing interference from the metal in the side wall 28 when the indicator 40 is in wireless communication with the sensor 42.

The tab 57 extends only about a portion of perimeter of the capsule 14. For example, the tab 57 may extend about 45 degrees about the perimeter of the capsule 14. The tab 57 thus provides a discrete portion. In alternative embodiments, the tab 57 extends around the complete perimeter of the capsule. The tab 57 may thus form a rim or flange. The indicator 40 may therefore be curved/arcuate, as shown in FIG. 10B.

The indicator 40 is at least partially embedded within the tab 57. Preferably, the indicator 40 is completely embedded/encapsulated within the tab 57. This helps to prevent damage to the indicator 40. The indicator 40 may be insert-moulded or over-moulded to the tab 57. The tab 57 may comprise the same material as the collar part of the carrier 55. Alternatively, the tab 57 may comprise a different material to the collar part, for example, to optimise bonding or embedding of the indicator 40. The tab, 57, may be permanently separated from the capsule 14, through a non-reversible operation. For example, the tab 57 may comprise a frangible portion.

In other embodiments, a tab 57 is not provided, and the indicator is mounted to the collar portion of the carrier 55.

As shown in FIG. 10E, the sensor 42 is provided in a suitable position to read the indicator on the carrier 55/tab 57. The sensor 42 may be position as described with reference to FIG. 10C. In some embodiments, the tab 57 is angled toward the base 26 of the capsule 14 (e.g. away from the rim 34). The tab 57 is therefore biased toward the sensor 42 when the capsule 14 in within the heating chamber 10. This helps to ensure the indicator 40 can communicate with the sensor 42. The tab 57 is interposed the capsule rim 34 and the heating chamber rim 52. The capsule rim 34 may engage the tab 57 and/or bias the tab 57 into engagement with the heating chamber rim 52.

A further embodiment of the carrier 55 is shown in FIG. 10F. The carrier 55 is configured to engage the rim/flange 34 of capsule 14. The carrier 55 may comprise a recess/groove configured to receive the rim 34. The carrier 55 may comprise a snap fit or interference fit with the rim 34. The indicator 40 is mounted is mounted on a carriage or insert 59 configured to be received within the carrier. The carriage 59 is received within a slot or recess in the tab 57. The carriage 59 is therefore insertable into the tab 57. The indicator 40 may be bonded or other fixed to the carriage 59. In other embodiments, the indictor 40 may be loosely held on the carriage 59. For example, the indicator 40 may be received with a recess in the carriage 59.

The carriage 59 may be sealed or otherwise permanently fixed to the carrier 55. This helps to prevent unauthorised tampering of the indicator 40. The carriage 59 may be adhered to the tab 57 and/or welded/fused thereto. In other embodiments, the carriage may be retained via latches or the like.

In some embodiments, the tab 57 is less than or equal to 1 mm in thickness. The tab 57 may therefore form a label and/or be flexible. This ensures the capsule 14 retains a close-fit with the heating chamber 10. Additionally or alternatively, a recess in the heating chamber rim 52 is provided to accommodate the tab 57.

In general, it can be seen the device 2 is configured to communicate with the capsule 14 when the capsule 14 is inserted/contained/received within the heating chamber 10. This ensures the device 2 communicates with capsule 14 that is configured to be heated. In alternative embodiments, the device 2 may be configured to communicate with a capsule 14 not provided in the heating chamber 10 (i.e. when the capsule 14 is exterior to the device 2). The sensor 42 may be provided on/adjacent an external portion of the device 2. For example, the sensor 42 may be provided on an external portion of the electronics housing 6 and/or lid 12. Alternatively, the sensor 42 is positioned such that the capsule 14 is capable of wireless communication therewith when exterior to the device 2. The user may then contact the sensor 42 with the capsule 14 and/or bring the capsule 14 into the wireless range thereof to initiate communication therebetween.

The indicator 40 is shown in detail in FIG. 11. The indicator 40 comprises a substrate 54. The substrate 54 may comprise a polymer or plastic. The substrate 54 may be flexible/bendable. This allows mounting of the indicator 40 onto non-planar sides of the capsule 14 (e.g. the side wall 28). The substrate may comprise an adhesive or the like to provide attachment to the capsule 14 (e.g. to provide a sticker or label). The indicator 40 may be attached after/during the capsule 14 manufacture process.

The memory device 56 is provided on and/or otherwise incorporated with the substrate 54. A plurality of contacts 58 are provided for contact the with sensor 42. Any number of contacts 58 may be provided. The contacts 58 are operatively connected to the memory device 56 (e.g. by tracks/wires).

The wireless indicator 40 is shown in FIG. 12. The wireless indicator 40 may be substantially the same as the contact indicator 40, however, an antenna 60 is provided in lieu of the contacts 58. The antenna 60 is generally convolute in form. For example, the antenna may labyrinth; spiral/concentric; undulating; and/or branched.

In embodiments, where the indicator 40 is provided on the rim 34, the antenna 60 may extend completely and/or partially around the perimeter of the rim 34. For the example, the antenna may be provided concentrically/spirally around the rim 34. This allows reading of the indicator 40 in any orientation thereof. The antenna 60 and/or memory 56 may be mounted to or embedded within the rim 34.

In some embodiments, the indicator 40 may be configured to be optically read by the sensor 42. The indicator 40 thus comprises a passive (i.e. non-electrical) marking. The indicator 40 thus comprises a visual indicator. The indicator 40 may be printed or otherwise deposited onto the capsule 14. The indicator may be provided on a substrate (e.g. sticker/label) and/or may be printed/deposited directly onto the capsule 14.

The sensor 42 comprises an optical sensor, for example, a photodiode or CCD array (e.g. camera) etc. The sensor 42 may comprise a light source to illuminate the indicator 40. For example, the light source may comprise scanning laser and/or or static light source (e.g. an LED). The sensor 42 comprises and/or is operatively connected to an image processing system. The image processing system decodes the visual indicator 40 to extract/determine data contained within the indicator 40. The image processing system thus converts the visual indicator 40 into machine readable data/code.

In the embodiment shown in FIG. 13, the indicator 40 comprises a 2-dimensional or matrix code. The code may comprise a QR code. The code may provide a binary code (i.e. the printed portions indicate a 1 or 0).

In the embodiment shown in FIG. 14, the indicator 40 comprises a barcode. The barcode may comprise any suitable form. Human readable characters may be provided with the barcode (e.g. to allow reading thereof by optical character recognition).

In the embodiment shown in FIG. 15, the indicator 40 comprises a colour code. The colour (e.g. wavelength/RGB) of the colour code may be determined by the sensor 42, thereby providing data to the device. The colour may be pre-associated with a specific instruction, code or product etc. For example, a specific first smoking product formulation is associated with a first colour, a specific second smoking product formulation is associated with a second colour, and so on. Alternatively, a specific colour is associated with a specific coded entity (e.g. a letter, number, character, string etc.). The colour of the indicator 40 may therefore provide a pseudocode. For example, RGB values of the indicator 40 may be determined. The RGB values may be associated with specific data in a database on the device 2. The system then retrieves the specific data in accordance with the observed RGB values.

The indicator 40 may comprise any number predetermined colours, in accordance with the sensitivity of the system. For example, the device 2 may be configured to detect between 5 and 100 different/discrete colours.

In some embodiments, a plurality of coloured indicators 40a-c may be used. This provides an Nth-base coded system (where N is number of discrete colours). For example, if 10 discrete colours are detectable, then indicator 40 shown in FIG. 15 can encode 1000 discrete variations. This allows encoding of a string or like and/or a greater number of variations. Although three indicators 40a-c shown in FIG. 15, it can be appreciated that any number indicators may be used

In some embodiments, encoding may be determined by the intensity (e.g. lightness/darkness) of the indicator 40. In some embodiments, encoding may be determined by the shading/hatching of the indicator. In some embodiments, encoding may be determined by the opacity/transparency of the indicator. In some embodiments, encoding may be determined by the shape, size, relative position/spacing and/or orientation of one or more indicator.

It can be appreciated the indicator 40 may comprise any suitable human and/or machine readable code. For example, a code may be directly provided on the capsule 14. The code may comprise a binary, alphanumeric and/or symbolic code. The code may comprise a plurality of dots or markings. The spatial position and/or orientation of the dots/markings may define a code. The code may comprise a human readable code. For example, the smoking formulation may be printed onto the capsule (e.g. “STRAWBERRY FLAVOUR”). The image processing system may comprise a character/image recognition system (e.g. OCR) to read/determine the code. The image processing system may then execute. transcribe and/or process the code accordingly. Such an arrangement allows the use of any suitable code, thereby providing a flexible configuration. The device 2 can be updated/reconfigured to recognise any new code, variables or configuration.

In some embodiments, the capsule 14 may be shaped and/or deformed to provide the indicator 40. The capsule 14 may comprise recesses, protrusions, ridges and/or indentations to provide a code. For example, the QR code or the barcode could embossed/debossed on the capsule surface. In other examples, a plurality of protrusions/recesses could provide a coded string.

In some embodiments, the indicator 40 is detachable or removable from the capsule 14. For example, the indicator 40 may comprise a detachable label or tag. The indicator 40 may be peelable from the capsule 14. The indicator 40 may comprise a line of weakness (e.g. perforations) to allow detachment from the capsule 14. The indicator 40 may be provided on one or more of the removable seals 32.

In some embodiments, the indicator 40 is separate or detached from the capsule 14. The indicator 40 may be provided on a separate label, card, tag or other substrate. The indicator 40 may be held loosely with the capsule 14. For example, the indicator 40 and the capsule 14 are loosely held within a package or wrapper containing the indicator 40 and the capsule 14. The indicator 40 may be attached to the capsule 14 via a wire, string, adhesive or the like.

In some embodiments, the indicator 40 is configured to change in response to use of the capsule 14. The indicator 40 may be configured to change in response to exposure of the capsule 14 to heat. This provides an indicator that the capsule 14 has previously been used and/or that the capsule 14 may have been exposed to undesirable temperatures during transport and/or storage thereof. The indicator 40 thus provided an indication the capsule 14 may provide a sub-optimal smoking experience. The sensor 32 may comprise an illumination device to illuminate the indicator 40.

The indicator 40 comprises a thermochromic material. The material thus changes the visual appearance thereof during exposure to an elevated temperature (i.e. above ambient temperature). The material may comprise a pigment or like. The pigment is incorporated into an ink. The ink is deposited/printed on to the capsule 14. The exact form of such thermochromic material is not pertinent to the invention at hand, and suitable formulations or compositions will be known to the person skilled in the art. The thermochromic material may comprise one or more of: a liquid crystal; leuco dye; metal oxide: and/or metal complex.

In the present embodiment, the thermochromic indicator 40 is provided on the upper surface 24 and/or rim 34 of the capsule (e.g. the capsule closure). The sensor 42 is provided on/within the lid 12 of the device 2 accordingly. The sensor 42 provides a line of sight with the indicator. As such, the sensor 42 is provided on the underside of the lid 12 (e.g. as shown in 9). The sensor 42 comprises a suitable optical sensor to detect the thermochromic change of the indicator 40 (e.g. a CCD or photodiode).

The indictor 40 may be provided on the upper seal 32. Thus, as shown in FIG. 17, the portion of the indicator 40 on the seal 32 is removed when the seal 32 is removed from the closure 24. A portion of the indicator 40 is therefore removable. Although the seal 32 is removed before use, the indicator 40 thereon may still indicate the capsule 14 has been exposed to elevated temperatures during storage/transport. Upon removal of the seal 32, the indicator 40 is only provided about the rim 34 of the capsule 14. In other embodiments, the indicator 40 may only be applied be applied to the rim 34 (e.g. to avoid wasting indicator material).

The indicator 40 is annular or ring-shaped. The ring is substantially continuous. The indicator 40 is provided at a same or similar radial distance from a centre 62 of the capsule 14 about the circumference thereof (e.g. the indicator 40 is rotationally self-similar). This ensures the indicator can be read in when the capsule is in any orientation in the heating chamber 10.

In some embodiments, the capsule 14 may comprise one or more discrete portions of indicator 40. Where the capsule 14 comprise N-fold symmetry, at least N portions of indicator 40 may be provided. For example, a capsule 14 with 1-fold symmetry requires only a single indicator portion 40, as the capsule 14 can only be inserted in a single orientation.

It can be appreciated the indicator 40 may comprise any shape, size or form. The indicator 40 may comprise a spot or patch. The indicator 40 may be applied directly to the capsule 14. The indicator may be applied to a label, sticker or removable substrate. The indicator 40 may be provided in any suitable location (e.g. lower wall 26 or side wall 28). The sensor may be provided in the side/lower wall of the heating chamber 10 accordingly.

As shown in FIG. 18, upon application of heat to the capsule 14 (i.e. a change in temperature thereof), the indicator 40 is configured to change colour. In some embodiments, the indicator 40 the emitted wavelength and/or spectrum of the indicator 40 may change in response to a change of temperature. For example, the indicator 40 may change from blue to red, white to green, black to white and so on.

In some embodiments, the intensity of the emitted light (i.e. brightness) may change in response to a change of temperature. For example, at a first temperature, the indicator 40 may be bright and a second temperature, the indicator 40 is dull. This may be provided by a change in the reflectivity and/or fluorescence of the pigment.

In some embodiments, the opacity/translucency of the indicator 40 may be configured to change in response to a change in temperature. For example, at first temperature, the indicator 40 is transparent/translucent, and at a second temperature, the indicator 40 is opaque. In a specific embodiment, the indicator 40 is configured to be transparent/translucent at an ambient temperature (i.e. less than 40° C.). The opacity of the indicator 40 may increase upon an increase in temperature. The indicator 40 is thus generally not visible to user at ambient conditions. In alternative specific embodiment, the indicator 40 is configured to be opaque at an ambient temperature (i.e. less than 40° C.). The opacity of the indicator 40 may decrease upon an increase in temperature.

A coloured portion may be provided beneath the indicator 40. Therefore, when the opacity of the indicator 40 changes, an apparent colour change of the indicator 40 is observed. In some embodiments, the coloured portion may comprise the colour of the capsule 14 (e.g. the natural colour thereof or the coating thereon). Alternatively, a coloured portion may be deposited into the capsule 14 and the indicator 40 is deposited onto the coloured portion.

In some embodiments, the indicator 40 may be configured to emit radiation in the non-visible spectrum (e.g. Infra-red/UV). The indicator 40 may emit non-visible radiation at ambient temperature and/or during a change of temperature. The indicator 40 is thus not visible or does not visibly change during heating of the capsule 14. Alternatively, the indicator 40 may only emit visible light during an increase of temperature. Thus, the indicator 40 may only be visible after heating.

In some embodiments, the indicator 40 may be only configured to emit radiation in response to non-visible radiation incident thereon. For example, the indicator 40 may fluorescent. The indicator 40 may be fluorescent in response to UV light. Thus, the indicator may not be visible and/or may not emit light without the use of a UV light.

Where the indicator 40 responds to/emits non-visible radiation, the sensor 42 may be configured to detect the non-visible radiation and/or the illumination device is configured to emit non-visible radiation accordingly. The sensor may comprise a UV/IR sensor and the illumination device may comprise a UV/IR source (e.g. UV/IR diode).

It can be appreciated the sensor 42 is configured to detect the change in wavelength, intensity and/or spectrum of radiation emitted by the indicator 40. Thus a “change in colour” may be construed as a change in wavelength, intensity and/or spectrum of radiation emitted by the indicator 40 accordingly.

In some embodiments, the indicator 40 is configured to progressively change colour with change in temperature (i.e. the colour change is continuous). This may allow the user to determine the temperature the capsule 14 has been exposed to. For example, the user may be able to compare the colour of the indicator 40 with a calibration chart to determine the temperature capsule 14 has been exposed to. In some embodiments, this may allow the device 2 to determine the current temperature of the capsule 14. This may provide feedback to the device 2, for example, to ensure the device 2 is operating at the correct temperature. Alternatively, this may allow visual inspection of the capsule 14 to allow manual adjustment of the temperature etc.

In some embodiments, the indicator 40 is configured to change colour in step wise fashion with change in temperature (i.e. the colour change is discrete/discontinuous). The indicator 40 may be configured to change colour at predetermined temperature. The predetermined temperature may be temperature at which the smoking product may become irreversible altered, thereby providing a sub-optimal smoking experience. Two or more predetermined temperatures may be provided. Thus, two or more discrete colour changes may be provided accordingly. For example, a first colour change may indicate the capsule 14 has been stored/transport above the first predetermined temperature. The first predetermined temperature may be approximately 60° C. A second colour change may indicate the capsule 14 has been heated in the device 2 above the second predetermined temperature. The second predetermined temperature may be approximately 100° C. The indicator 40 can thus indicate that the capsule 14 has been exposed to one or more different temperatures.

The colour change may saturate (i.e. cease changing) at a predetermined temperature. This temperature may be determined according to the desired operating parameters of the device 2 or smoking product. For example, the colour change may saturate at a temperature greater than or equal to 60° C.; preferably, greater than or equal to 100° C.; preferably, greater than or equal to 150° C.

In some embodiments, the change in colour of the indicator 40 may be irreversible. Thus, once the indicator 40 has changed from an original colour to a new colour, the indicator will not revert to the original colour, even if the temperature is reverted back to ambient temperature. This provides a permanent or semi-permanent indicator that the capsule 14 have been exposed to an elevated temperature. The indicator 40 may therefore provide a tamper-evident indicator 40.

In other embodiments, the change in colour of the indicator 40 may be reversible. This may allow monitoring of the temperature of the capsule 14 during heating thereof (e.g. to provide feedback to the device 2). The monitoring may be provided in real-time.

In some embodiments, the indicator 40 is configured to indicate the freshness of the smoking product 30. The indicator 40 may comprise a material configured to change colour over time (i.e. the colour of the indicator is time-dependent). Thus, the colour of the indicator 40 may provide an indication of the time since manufacture thereof. In some embodiments, the indicator 40 changes colours in response to exposure to oxygen. This may indicate oxidation of the smoking product 30. In some embodiments, the indicator 40 changes colour in response to moisture and/or liquid.

In some embodiments, the hookah device 2 may read or communicate with the indicator 40 via an intermediate device 64. The intermediate device 64 is separate/distinct from the hookah device 2. Typically, the intermediate device comprises an electronic or computing device, for example: a fob; touchscreen device; button/selector device; a mobile (cellular) phone; tablet computer; laptop computer etc. In some embodiments, the intermediate device may comprise a dedicated user/sensor interface device for use with the device 2, for example a reader or NFC device.

The intermediate device 64 is connected to the device 2 for transmission of signals from the intermediate device 64 to the device 2 and/or vice versa. The intermediate device may therefore transmit the indicator 40 data and/or data relating thereto. In the present embodiment, then intermediate device 64 is wirelessly connected to the hookah device 2. Any suitable technology may be used, for example: Wifi; Bluetooth (RTM); NFC, IrDA etc. The intermediate device 64 and the hookah device 2 comprise a wireless communication interface respectively. The intermediate device 64 could comprise a remote device (i.e. capable of operating at a separate location from the hookah device 2). In other embodiments, the connection between the hookah device 2 and the intermediate device 64 may be wired.

The hookah device 2 may connect to the intermediate device 64 via an intermediate server or the like. For example, the device 2 may connect to the intermediate device 64 via the internet or via a local network connection, or via a direct connection therewith.

The intermediate device 64 comprises a sensor 66 configured to read/interrogate the indicator 40 on the capsule 14. The sensor 66 may be substantially the same as the sensor 42 previously described. In the embodiment shown in FIG. 19, the sensor 66 comprise a camera. The camera may capture one or more image of the indicator 40. In other embodiments, the sensor 66 may comprise an NFC sensor. The NFC sensor may read/interrogate data on the indicator 40.

In some embodiments, the intermediate device 64 may merely transmit data from the indicator 40 to the hookah device 2, e.g. without modification or else with a validation indicator. The intermediate device 64 acts as a pass-through or relay device. The data from the indicator may be interpreted/processed on hookah device 2. In further examples, the intermediate device 64 may modify, redact or supplement the indicator 40 data or portions thereof. The intermediate device 64 may be used to implement user preferences or selections for example.

In some embodiments, the intermediate device 64 is configured to interpret/process data from the indicator 40. The intermediate device 64 may extract one or more data portions (e.g. data fields) from the indicator data. The data and/or data portions may then be stored in memory on the intermediate device 64. The intermediate device 64 may comprise software (e.g. an app) configured to read/extract/process the indicator data.

The intermediate device preferably provides a user interface. The intermediate device 64 may present information relating to the capsule 14 to the user, e.g. on a display. The information may comprise one or more of the extracted data portions/fields. For example, as shown in FIG. 19, the intermediate device 14 may indicate the flavour; authenticity; heating temperature/profile; and/or heat exposure indicator to the user. This allows the user to inspect and/or interrogate the capsule 14 without inserting the capsule 14 into the hookah device 2.

The intermediate device 64 may send indicator data and/or portions thereof to the hookah device 2. The data sent to the hookah device 4 may comprise all of the data or extracted fields. Alternatively, the intermediate device 64 is configured to transmit only a portion of the data or extracted fields to the hookah device 2. In some examples, the select portion of data/fields is predetermined in accordance with the operating parameters of the hookah device 2. For example, the hookah device 2 may be able to operate effectively with only the heating temperature/profile transmitted thereto.

In embodiments with the intermediate device 64, the hookah device 2 may further be configured to read the indicator 40 as previously described. Thus, the intermediate device 64 may used in conjunction with the hookah device 2, for example, to merely verify the contents of the capsule 14 before use or modify the data read by the device directly from the indicator 40.

In some embodiments, the intermediate device 64 is configured to provide bi-directional communication with the hookah device 2. The hookah device 2 may therefore send data to the intermediate device 64. The hookah device 2 may send the indicator data and/or portions thereof to the intermediate device 64. The intermediate device 64 may display the indicator data and/or portions thereof. The hookah device 2 may send operating/heating information to the intermediate device 64. For example, the hookah device 2 may send sensor data (e.g. temperature of the heater 10) to the intermediate device 64. The hookah device 2 may send status updates and/or error messages to the intermediate device 64. The intermediate device 64 may therefore operate as external display for the hookah device 64.

In one example of use, the capsule indicator data may comprise a plurality of different heating profiles for the capsule and the intermediate device may be used to select one of the heating profiles for implementation by the device 2. The profiles could for example comprise mild, normal and aggressive heating profiles for an individual user, or different session durations. The profiles could comprise a ‘group’ or ‘party’ mode whereby the device is intended to be used many users, which requires a different heating profile from a single user.

FIG. 19B shows the use of an intermediate device 64 configured to communicate directly with the indicator 40 (i.e. transmit data thereto). The intermediate device 64 may not communicate directly with device 2. The intermediate device may write or modify data on the indicator 40. This may allow customisation/optimisation of date or instructions (e.g. a heating profile, operation time or pause times) provided on the capsule 12. Additionally or alternatively, data transmitted from the intermediate device 64 to the indicator 40, may be further transmit to the hookah device (e.g. when the capsule is inserted therein). This may allow upgrading or enhancing the functionality of the device 2, without requiring connectivity of device 2 to a public network (e.g. the internet).

As previously discussed, the indicator 40 may information/data relating to one or more parameters or properties of the capsule 14 and/or the smoking product 30. The indicator 40 may comprise data relating to, one or more of, inter alia:
One or more flavouring of the smoking product 30. This may comprise a broad qualitative indicator (e.g. “Sweet” or “Sour”) and/or specific qualitative flavour (e.g. “Strawberry” or “Bubble-gum”).
One or more ingredient of the smoking product 30. This may include a list of all, or a portion of the ingredients (e.g. active ingredients). The list may comprise a weight/volume of one or more of the ingredients and/or the relative proportion thereof. One or more allergens may be indicated. The indicator 30 may indicate whether the smoking product 30 contains tobacco and/or a nicotine-containing product.
Composition or type of the smoking product 30. This may indicate the general form of the smoking product, for example, whether the smoking product 30 comprise tobacco, inert beads, a paste and/or combinations thereof.
Amount (e.g. weight/volume) of the smoking product 30 and/or size (e.g. weight/volume/dimensions) of the capsule 14.
A heating temperature of the smoking product 30. This indicates a preferred or optimal temperature for the smoking product 30 during heating thereof to ensure an optimal smoking experience.
A heating profile and/or power profile of the smoking product 30. This indicates a preferred or optimal temperature time-dependent profile for the smoking product 30 during heating thereof to ensure an optimal smoking experience. This will be described in detail later.
A pause profile to determine the length and/or temperature of pause event. The pause profile may be customised by the user. The pause profile may determine the length of each smoking session and/or provide a corresponding heating profile when the session is unpaused.
Data relating to the manufacture or distribution of the capsule 14. For example, one or more of: batch number; manufacture date/time; quality control marker; manufacturer identifier; supplier identifier; distributor identifier.
Data relating to the integrity of the smoking product 30, such as use-by date; or expiry date. This may be provided by the heat exposure indicator (e.g. thermochromic pigment). In some embodiments, the hookah device 2 may write data to the indicator 40 to indicate the capsule 14 have been heated or used. The indicator 40 may therefore comprise a marker or flag.
Data authenticating the capsule 14. This allows the user to verify the capsule 14 is authentic. The authentication may comprise a unique code/cipher, hash, authentication token and/or signature. This may be verified against a database of known codes (e.g. using an internet-connected database). In some embodiments, the data may comprise a self-validating code/string. For example, the code may comprise one or more check digit or checksum.
Usage restrictions. This may comprise an age restriction, for example, where the smoking product 30 comprises tobacco, alcohol, caffeine or other age restricted goods. The age restriction may indicate a number (e.g. 16, 18 or 21) and/or be qualitative (e.g. “Child”, “Adult” etc). In some embodiments, the smoking product 30 and/or specific capsule 14 may associated with a specific user or class of users. For example, this may be used where the smoking product 30 comprises a prescription or other controlled ingredient, such as cannabis. The data may comprise a user ID. The data may comprise a user name and/or unique code.
Checksum. The checksum may be used to verify the data and/or portions thereof stored on the indicator 40.

It can be appreciated the parameters may be stored as database fields or the like. The hookah device 2 and/or the intermediate 64 may therefore extract and/or process any of the fields as previously described.

A heating profile 68 for a capsule 14 and/or smoking product 14 is shown in FIG. 20. The heating profile 68 defines an optimal or preferred heating temperature for the capsule 14 as a function of time. The heating profile 68 may be determined using any suitable method, as will be understood by the person skilled in the art. Typically, the heating profile is dependent one or more of: type/composition of smoking product 30; weight/volume of smoking product 30; and/or shape/size and/or thickness of the capsule walls.

In some embodiments, the heating profile 68 may be fixed or standardised for the particular smoking product 30 and/or capsule 14. Thus, the indicator 40 for each capsule 14 containing said product 30 comprises substantially the same heating profile data.

In other embodiments, the heating profile 68 may vary between different capsules 14 containing the same smoking product. This may allow variation of the heating profile 68 to accommodate variation in manufacture of the smoking product 30, for example, due to differing temperature, humidity or starting materials. The smoking product 30 may be periodically sampled and the heating profile 68 determined accordingly. The smoking product 30 may be sampled at predetermined intervals and/or between batches.

The temperature of the capsule 14 is generally controlled by controlling the temperature of the heater 10. Typically, the heat output of the heater 10 is controlled by varying the electrical power thereinto. The heating profile 58 may therefore provide a power profile. The hookah device 2 comprise a monitoring system to monitor the temperature of the heater 10 and/or capsule 14. The monitoring system may comprise a thermometer operatively connected to or engaged with the heater 10 and/or capsule 14. The thermometer may comprise one or more of: a thermocouple; infrared thermometer;

electrical resistance thermometer etc. In some embodiments, the monitoring system may use the colour change of the capsule indicator 40 to indicate the temperature thereof.

The hookah device 2 may be configured to heat the capsule 14 at a plurality of different temperatures. The heating profile 68 therefore comprises a plurality of different temperatures (i.e. different temperature levels). This provides a plurality of different heating phases. For example, the heating profile 68 comprises a first temperature 70 and a sequential second temperature 72. The heating profile may be maintained at a given temperature for a predetermined period of time 74. The first temperature 70 is greater than the second temperature 72 to ensure the smoking product 30 in the capsule 14 is uniformly brought to the desired temperature. The user may not smoke the hookah device 2 during this period. This provides an initial “warming up phase”. The second temperature 72 may then provide a temperature in which the user inhales the vaporised smoking product 30. This provides a “smoking phase”.

The change between the first temperature 70 and second temperature 72 may be instantaneous. Thus, the change/boundary between the first temperature 70 and second temperature 72 is step-like or discontinuous.

The heating profile 68 may change continuously over a given time period 76. For example, the heating profile 68 may steadily decrease over period 76. This provides a “ramping down” of the temperature to prevent burning of the smoking product 30 is depleted (i.e. the temperature is proportional to the remaining mass of unconsumed smoking product 30)

In some embodiments, the hookah device 2 is configured at change the temperature of the heater 10 in response to inhalation of the user. Typically, the temperature increases to counteract the cooling effect of the incoming air. Additionally, or alternatively this increases the amount of vapour produced by the smoking product 30 to provide an improved smoking experience. This provides a proactive means of ensuring quality of smoking experience. The increase in temperature may provide inhalation events 78 within the heating profile 68. Thus, the heating profile 68 merely provides a baseline for the temperature of the heater 10, and the temperature thereof may vary in accordance with inhalation of the user.

The increase in temperature may be at least 5° C.; preferably at least 10° C.; preferably at least 20° C. Additionally or alternatively, the temperature of the during the inhalation event 78 may comprise an absolute temperature. The absolute value may be stored on the indicator 40. The increase in power to the heater 10 may be at least 3%; preferably, at least 5%; preferably, at least 10.

Inhalation may be detected via an inhalation sensor. The sensor may comprise a pressure sensor or the like. The pressure sensor may comprise a resistive, capacitive and/or inductive pressure sensor. Additionally or alternatively, the sensor comprises a mechanical airflow sensor. For example, the sensor may comprise a flap or diaphragm configured to move during inhalation. The flap/diagram may be connected to a potentiometer or the like. Additionally or alternatively, the sensor comprises of an accelerometer measuring vibration in the system, caused by the inhalation and formation of bubbles. The sensor may be located in any suitable position in the air pathway, or outside the air pathway, between the mouthpiece 22 and the inlet apertures 17. The inhalation sensor is operatively connected to the heater controller to control power flow to the heater 10.

In some embodiments, the inhalation event 78 is configured to activate only during periods of inhalation. The increase in power to the heater 10 is thus only provided during inhalation. In some embodiments, the inhalation event 78 is configured to activate for a predetermined period of time. The increase in power to the heater 10 is thus provided for a predetermined period of time once inhalation in detected. The predetermined period of time may initiate at the beginning or end of the user inhalation.

In some embodiments, the inhalation event 78 is configured to attempt to only offset the cooling effect of the inlet air. The heater 10 therefore attempts to maintain the heating profile 68 temperature. The temperature loss during inhalation may be pre-calibrated. For example, if a 10° C. drop is observed during inhalation in a calibration experiment, this value is stored on the device, and then the heater temperature is configured to increase by 10° C. when an inhalation event is detected accordingly. The heating profile 68 is therefore maintained. It can be appreciated that cooling effect may be proportional to the inhalation rate. The device 2 may be configured to determine the inhalation air flow rate and adjust the increase in temperature accordingly. The device 2 therefore predicts a temperature decrease in the heater 10 temperature and adjusts power to the heater 10 to at least partially offset the decrease.

In some embodiments, the heater 10 is configured to reactively adjust to inhalation of the user. The device 2 may therefore monitor the temperature of the heater 10. If the temperature is reduced during heating, then power thereto in increased. The heater 10 thus attempts to track the heating profile 68 temperature. Whilst such an arrangement does not require the user of an inhalation sensor, the smoking experience may not be suboptimal.

The heating profile 68 may comprise any number of heating temperatures/levels. One or more temperatures may be repeated in the heating profile. The heating profile 68 may therefore be cyclical/undulating. The time period 74 at each temperature may vary between temperatures. The boundary/ramp may comprise any suitable gradient. The gradient may vary between different temperature boundaries/ramps. The heating profile 68 may varying continuously and/or discontinuously. The heating profile 68 may be curved and/or comprise linear portions.

In a first embodiment, the general form (i.e. shape) of the heating profile 68 is stored on the hookah device 2. The hookah device 2 may store one or a plurality of heating profiles 68. The indicator 40 is configured is to contain data configured to modify the pre-stored/pre-defined heating profile 68.

As shown in FIG. 21, in some embodiments, the indicator data comprises a modifier configured to modify the temperature values, power values and/or time values of the heating profile 68. For example, in heating profile 68A, the modifier changes the temperature or power of the heating profile 68. The modifier may comprise a simple scalar modifier (e.g. the heating profile 68 is multiplied by a scalar value). In the present examples, the scalar modifier is >1, thereby increasing the heating profile 68 temperature or power. As the modifier is a simple scalar modifier, the temperature/power across the whole heating profile 68A is modified. Such an arrangement provides a simple variation of the heating profile 68 to suit the temperature requirements of the smoking product 30. A low temperature smoking product 30 may have relatively lower modifier value and vice versa.

In the heating profile 68B, the modifier changes the total time period 80 of the profile 68. The modifier may comprise a simple scalar modifier. Such an arrangement provides a simple variation of the heating profile 68 to suit the amount/size of the smoking product 30 and/or capsule 14. A relative low smoking product 30 weight/volume may have relatively lower modifier value and vice versa.

In some embodiments, the modifier is configured to modify only select portions of the heating profile. The modifier may only modify the temperature/time period 74 of a select portion of temperature levels. For example, the modifier may only modify the temperature and/or time period 74 of the warming up phase and/or the smoking phase.

In some embodiments, the modifier may be configured to provide temperature and/or time period data for each phase. Thus, whilst the general form of the heating profile remains constant, the time period and temperature of each phase may be varied independently. A modifier may be applied automatically by the device 2 upon reading the capsule indicator 40 or else could be manually selected by the user, e.g. using the intermediate device 64.

In some embodiments, a plurality of different heating profiles 68 may be stored on the device 2. The indicator 40 may therefore comprise an indication of the specific heating profile 68 required. The specific heating profile 68 is thus selected in accordance with the inserted capsule 14 and/or smoking product 30. This allows a plurality of different heating profiles to be provided whilst retaining minimal data on the indicator 40.

An example of the data structure on the indicator 40 is shown in FIG. 22. The data comprises an identifier 82 relating to the smoking product 30 and/or capsule 14. The hookah device 2 may read/interpret the identifier 82 to identify the smoking product 30/capsule 14 accordingly. The data comprises a heating profile indicator 84 configured to indicate a specific heating profile 68 pre-recorded on the hookah device 2. Thus, when the data is read by the hookah device, the heating profile 68 is selected accordingly. Whilst, the data of FIG. 22 includes only temperature and time, a practical example of the invention may also include a power setting for the device/heater.

In some embodiments, the product/capsule identifier 82 may be associated with a particular with a specific heating profile 68 in the memory of the hookah device. Thus, the hookah device 2 automatically selects a heating profile in accordance with the product/capsule identifier 82.

In some embodiments, the pre-recorded heating profile 68 may be manually selected by the user. For example, the capsule 14 and/or associated packaging may comprise printed instructions for the user. The user may manually select the heating profile via a manual input on the hookah device 2 (e.g. button or dial etc.) and/or may use the intermediate device 64.

The data may comprise a phase identifier 86. This identifies and/or delineates the different phases (e.g. different temperature or power levels). The data comprises a temperature indicator 88 to indicate the desired temperature for each phase. The temperature indicator 88 may indicate a fixed temperature and/or temperature gradient (e.g. change in temperature per unit time). The data comprises a time interval indicator 90 to indicate the desired time interval/period for each phase. The data may then comprise temperature and time period data for each phase accordingly. The hookah device 2 can therefore read the data for each phase and construct a heating profile 68. It can be appreciated that instead of providing a temperature or time period value, a temperature and/or time period modifier may be provided.

With reference to FIG. 23, in some embodiments, the optimal/preferred heating profile 68 may be sampled at a number of points 92. As shown in FIG. 24, the sample points 92 may be stored on the indicator 40. The sample points 92 comprise a temperature and/or power indicator 96. The sample points 92 comprise a time indicator 98 corresponding the temperature and/or power indicator 92. The sample points 92 thus provide co-ordinates or the like.

As show in FIGS. 25A and 25B, the sample points can be processed by the hookah device 2 to provide a reconstructed heating profile 94. Providing specific data points or coordinates on the capsule indicator 30 allows the hookah device 2 to operate using input only from the capsule 14. This mitigates the need to store any pre-programmed profiles or the like on the device 2. The device 2 can therefore accept any suitably formatted profile, with any level of complexity. This provides a future-proof arrangement, as heating profiles can be changed or created during the capsule manufacturing/programming stage, without the need to modify/update the device 2. The hookah device 2 may therefore comprise a “dumb” device, where heating profile instructions are merely inserted thereinto.

In embodiment shown FIG. 25A, the hookah device 2 is configured to interpolate and/or extrapolate between the sample points 98. This provides a continuous heating profile 68. The heating profile may therefore comprise heating gradients. In the embodiment shown in FIG. 25B, the hookah device 2 may merely change to the indicated temperature 96 at the indicated time 98 in a stepwise fashion. The temperature in each phase remains substantially constant. The sample points 92 may therefore provide boundary points for a number of phases.

A power setting for each phase may comprise a max/threshold power or a substantially constant power for that phase.

In the present embodiment, sample points 92 are only provided at the boundaries between different phases of the heating profile. The sample points 92 are therefore only provided at points where the heating profile 68 changes gradient (e.g. turning or inflection point) and/or in stepwise fashion. This provides the minimum amount of sample points whilst generally providing an accurate/representative heating profile 68.

In some embodiments, the sample points 92 are provided at predetermined time intervals. For example, the sample points 92 may be provided at a fixed interval. This may be beneficial where the heating profile 68 is complex. Where the samples points are provided at a fixed interval, the time indicator 98 need not be provided in the indicator data as the fixed interval may be pre-programmed into hookah device 2. Additionally or alternatively, the indicator data may specify the fixed time interval and the hookah device 2 constructs the heating profile accordingly.

As shown in FIG. 26, the heating profile 68 may be smoothed. This provides a continuous and/or step-free heating profile 68. This may achieved by applying a smoothing algorithm to the heating profile 68. The heater 10 then heats the capsule 14 according to the smoothed heating profile. Additionally or alternatively, the heater 10 may be configured to heat the capsule 14 in a smooth fashion. regardless of the heating profile 68. For example, the heater 10 may be controlled using PID controller. This prevents over-shooting of and/or fluctuation about the desired temperature etc.

It can be appreciated that the heating profile 68 merely provides a desired heating temperature. In practice, the actual temperature achieved may vary for a number of reasons, for example: thermal lag; feedback/sensor lag; user inhalation; air temperature;

and/or other unanticipated thermal variations. Thus, the heater 10 is configured to continually adapt the temperature thereof to reaches the specified heating profile 68. The actual temperature may oscillate about and/or toward the desired temperature.

In some embodiments, the indicator 40 may comprises a plurality of heating profiles 68. The heating profile 68 may be modified according to one or more usage condition. For example, the user may want an “intense” smoking experience. The heating profile may therefore operate at a higher temperature during one or more phase thereof. Conversely, the user may require a “mellow” experience, in which the heating temperature is relatively lower. Alternatively, the user may specify the number of users for a smoking session. The heating profile may therefore operate at a higher temperature to accommodate the increase in smoke required for an increased number of users. The user may select any such modifications using the intermediate device 64 as described above. It can be appreciated the heating profiles can be varied according to one or more of:
Smoke intensity;
Smoking time;
Number of users;
Number of pauses permitted in the session, time permitted for each respective pause, or total pause time;
Indication of capsules or combinations thereof used in a multi-capsule session (i.e. when stacked as previously discussed).

The duration, power and/or temperature of each phase of the heating profile and/or inhalation temperature may be varied according to the usage condition. The overall shape (i.e. the relative temperatures of each phase) may be varied according to the usage condition. A finite number of heating profiles 68 may be provided according with a discrete selection by the user. For example, the user may select “high”, “medium” or “low”. Additionally, the heating profiles may be variable according to an arbitrary scale. For example, the user select a value between 1 and 10.

It can be appreciated the heating profile(s) 68 and/or corresponding time/temperature values described above, and provided in the accompanying drawings, are arbitrary and are merely used to illustration the invention at hand. The heating profile 68 and the corresponding data may take or be recorded in any suitable form.

In the above embodiments, parameters relating to capsule 14 and/or smoking product 30 are stored on the indicator 40. The indicator 40 is then read/interrogated by the hookah device 2 and the parameters are processed accordingly. This arrangement is shown schematically in FIG. 27. It can be seen the capsule/product parameters 100 are read/interrogated by hardware/software 102 on the hookah device 2. The hardware/software 102 may comprise programmable logic (e.g. FPGAs) and/or firmware or the like. The hardware/software generally comprises a “low-level” system/language. The parameters 100 are then processed by executable code 104 located on the hardware/software 102. The executable code 104 is stored in memory on the hookah device 2. The executable code 104 generally comprises a “high-level” system/language. The executable code 104 may process the parameters 100.

The executable code 104 and/or device software 102 (e.g. firmware) may be changeable and/or replaceable (i.e. the memory is re-writable). This allows the hookah device 2 to be updated, for example, to provide additional or different heating profiles etc. The hookah device 2 may be internet connectable and/or be configured to receive code updates from the intermediate device 64.

In an alternative embodiment shown in FIG. 28, the executable code 104 is configured to be stored on the indicator 40. The indicator 40 thus comprises high-level executable code. The hookah devices 2 is configured to read/interrogate the indicator 40 and extract the executable code 104 therefrom. The executable code 104 may be stored in memory on the hookah device 2. The executable code 104 is then executable by the hookah device 2. The parameters 100 can be extracted from the indicator 40 and processed by the executable code 104.

The executable code 104 is stored on the indicator 40 such that the executable code 104 is accessible from an external device. For example, the executable code 104 is stored in a portion of memory accessible from an external device. Additionally or alternatively, the indicator 40 may be configured to transmit the executable when interrogated (e.g. where the indicator 40 is an NFC device). The code may comprise open/plain-text or be encrypted.

The executable code 104 may be stored on the hookah device 2 in a permanent or persistent fashion. This allows updating of the hookah device 2 with new executable code.

In some embodiments, the executable code 104 may be stored on the hookah device 2 is semi-permanent or temporary manner. For example, the executable code 104 may be replaced when the hookah device 2 reads/interrogates a new indicator. Thus, the executable code 104 can be tailored to a respective capsule 14 and/or smoking product 30. For example, this may allow heating profiles 68 to be customised. Additionally or alternatively, this may allow the hookah device 2 to provide function not previously possible with the existing executable code 104.

In some embodiments, the executable code 104 may be removed after a predetermined period of time. In some embodiments, the execute code 104 may be removed once the power to the hookah device is removed (e.g. the executable code may be stored in non-volatile RAM). In some embodiments, the execute code 104 may be removed in response to a heating cycle completing and/or removal of the capsule 14 from the hookah device 2.

In some embodiments, if the executable code 104 is not provided (e.g. the code 104 has been erased), the hookah device 2 is configured to be unfunctional. For example, the hookah device 2 may not active the heater 10. This prevents unauthorised use or tampering of the hookah device 2. For example, this may prevent the hookah device 2 operating with a capsule 14 inserted. Where executable code 104 is not provided, the hookah device 2 generally only comprises low-level systems. Such low-level systems may only provide basic functionality, for example, providing reading/interrogation of the indicator 40. The hookah device 2 may provide a “dumb” system. The system may therefore listen/wait for instructions from an indicator 40 on the capsule 14 and/or via the intermediate device 64.

The method of operation of the hookah device will be described with reference to FIG. 29. In an initial step 106, the capsule 14 is inserted into the hookah device 2. The capsule 14 is placed within the heating chamber 10. The capsule 14 provides a close fit within the heating chamber 10 to ensure good thermal contact therewith. The lid 12 is then closed over the capsule 14 to enclose the capsule within the heating chamber 10. The lid 12 may engage and/or seal against the capsule 14. Power to the hookah device 2 may be provided before and/or after insertion of the capsule.

In the next step 108, the hookah device 2 reads/interrogates the indicator 40. The hookah device 2 extracts and/or process data on the indicator 40 as previously described. This may be performed directly by the hookah device 2 and/or via the intermediate device 64.

The hookah device 2 may be configured to periodically attempt to read/interrogate/inspect the indicator 40 to detect the presence thereof.

In some embodiments, the hookah device 2 is configured to transmit an authentication code/token to the indicator 40. The indicator 40 then interprets the authentication code to determine is the code is authentic. If the code is deemed as authentic/valid, the indicator 40 may initiate and/or permit further communication with the hookah device (i.e. transmits the data thereon). If the code is not deemed as authentic/valid, then further communication is prevented. Communication may then be prevented until a valid authentication code is transmitted by the hookah device 2. This prevents unauthorised probing or extraction of data from indicator 40, ensuring integrity thereof.

The authentication code may take any suitable form and/or use any suitable technology, as previously described with reference to capsule authentication code. The authentication code may comprise an Advanced Encryption Standard (AES) code/cipher.

In the next step 110, the hookah device 2 verifies the integrity of the capsule 14 and/or the smoking product 30. This may take a number of forms, for example, one or more of:
Validating the authentication code/signature. The hookah device 2 comprises an algorithm to process the authentication code to determine whether the code is authentic. The algorithm may comprise a hash algorithm. The hookah device 2 may be configured to provide a time delay between providing respective validation processes. For example, where one capsule 14 is inserted into the hookah device 2, validated, removed and then a second capsule 14 is inserted, the second validation process for the second capsule 14 will only initiate after the time delay. The time delay may be greater than or equal to 0.1 s; preferably, greater than or equal to preferably, greater than or equal to 1 s; preferably, greater than or equal to 2 s. This may help to prevent reverse engineering of the validation code via a brute force attack. In some embodiments, the delay may be greater than or equal to 30 seconds.
Determining whether the capsule 14 has been exposed to an undesirable temperature. For example, by determining the colour of the thermochromic indicator.
Determining whether the smoking product is within/outside an expiration date.
Determining the capsule 14 is correctly located within the heating chamber 10 (e.g. whether the indicator 40 is properly readable/interrogable).
Determine the type/size/weight of smoking product 30 is suitable for use the hookah device 2.
Determine if the usage restrictions are satisfied. The hookah device 2 and/or intermediate device 64 may comprise a record of the user credentials. For example, a user profile is stored on hookah device 2 and/or intermediate device 64. The system verifies whether the age and/or ID of the user matches the credentials on the user profile.
Verifying the data checksum. If the checksum fails, then reading/interrogation of the indicator 40 is performed again.

In the event the hookah device 2 determines capsule 14 and/or the smoking product 30 does not meet the required integrity and/or restriction parameters, the hookah device 2 may initiate an end routine 112. In the end routine 112, the hookah device 2 prevents any heating of the capsule 14 (i.e. does not activate the heater 10). A notification may be provided to indicate the cause of failure to meet the integrity parameters. For example, “AUTHENTICATION FAILED” or “CAPSULE PREVIOUSLY HEATED” messages may be provided. The notifications may be provided as an error code or the like. The notifications may be provided by visual indicators on the hookah device 2 (e.g. LEDs or a visual display). The notifications may be provided directly on the hookah device 2 and/or provided via the intermediate device 4.

In the next step 114, the hookah device 2 is configured to eject the capsule 14. This may occur either automatically or manually. The hookah device 2 comprises an ejection mechanism configured to eject the capsule 14 from the heating chamber 10 accordingly. The lid 12 may be configured to open as part of the capsule ejection (e.g. the lid 12 and the ejection mechanism may be operatively connected via a linkage etc.). Additionally or alternatively, a notification is provided for the user to manually remove the capsule 14.

It can be appreciated that the above validation step 110 may be performed by the intermediate device 64. The intermediate device 64 may send a signal to the hookah device 2 to indicate the integrity check is successful and/or unsuccessful.

In the event the hookah device 2 determines capsule 14 and/or the smoking product 30 do not meet the required integrity parameters, the hookah device 2 may prevent initiation of a heating profile loading step 116. The heating profile 68 is extracted and processed from data on the indicator 40. The heating profile 68 may loaded into memory on the hookah device 2.

In embodiments where the thermochromic indicator 40 is provided, an initial heating step 118 may be provided. This initial step heats the capsule 14 to a predetermined temperature. Typically, the predetermined temperature is greater than or equal to a maximum temperature at which the smoking product 30 maintains integrity (i.e. the temperature at which the smoking product 30 is irreversibly compromised). The predetermined temperature is typically less than the heating profile temperature to prevent any potential undesirable off-gas from an unauthentic product. The predetermined temperature may be greater than or equal to 50° C., preferably, greater than or equal to 60° C. The predetermined temperature may be less than or equal to 120° C., preferably, less than or equal to 100° C. The capsule 14 may be heated at the predetermined temperature for a pre-determined period of time. The pre-determined period of time may be between 1 and 10 minutes, preferably between 2 and 8 minutes.

In the next step 120, the colour of thermochromic indicator is determined during and/after the heating step 118. A change in colour (or lack thereof) is determined by the hookah device 2. The change in colour may determine whether the capsule has previously been exposed. For example, if no colour change is measured, then the capsule 14 may have been exposed to excess heating during transport/storage. If the capsule 14 is deemed to have been exposed to excess heating, then the hookah device 2 may begin the end routine 112. The hookah device 2 may provide a notification accordingly.

If the capsule 14 is deemed to not have been exposed to excess heating and/or in embodiments where thermochromic indicator is not provided, then the hookah device 2 may begin the heating step 122. In this step 122, the heater 10 heats the capsule in accordance with the predetermined heating profile 68. The user may then inhale/smoke the smoking product 30 as required.

During the heating step 122, the hookah device 2 is configured to monitor for a “pause” event 124. The pause event 124 is configured to indicate the user wishes to pause usage of the device for a period of time. During the pause event 124, the heater 10 may reduce the temperature thereof. The electrical power to the heater 10 may therefore be reduced. In some embodiments, the temperature may only be partially reduced. For example, if the heater is configured to operate in a normal condition at 180° C., during a pause event, the heater 10 may operate a 100° C. The pause temperature may be less than or equal 80% of the normal temperature; preferably, less than or equal 60%; preferably, less than or equal 50%.

In other embodiments, the temperature is reduced to ambient temperature. The electrical power to the heater 10 may therefore be zero. This may prevent excessive combustion of the smoking product 30.

Upon detection of the pause event 124, the heater 10 temperature is reduced. The pause event may continue until a “resume” event 126 is triggered. The resume event 126 indicates the hookah device 2 continues heating the capsule 14 in accordance with the heating profile 68. Thus, the pause event 124 may continue for an indefinite period of time.

In some embodiments, the pause event 124 may be configured to extend for a predetermined period of time. Once the predetermined period of time has elapsed, the hookah device 2 may continue with the heating step 122. The user may be able to select and/or define one or more time period. For example, an option to pause heating for 1minute, 5 minutes or 20 minutes may be provided. Each option may comprise a respective input (e.g. button).

The pause/resume event is generally initiated by the user. The pause/resume event may be initiated by a manual input on the hookah device 2 (e.g. a button/dial or the like) and/or via the intermediate device 64.

During operation, the hookah device 2 is configured monitor the position of the lid 12. The hookah device 2 is configured monitor whether the lid 12 is provided in the closed and/or open position. A sensor is provided to determine the position of the lid. The sensor may comprise an optical and mechanical sensor (e.g. a contact/push sensor or the like). If the lid 12 is detected as being the open position, the hookah device 2 is configured to initiate the end routine 112. The heater 10 is therefore configured to deactivate in response to open of the lid 12. The capsule 14 may then be ejected. This may prevent overheating of the hookah device 2.

In other embodiments, If the lid 12 is detected as being the open position, the hookah device 2 is configured to initiate a pause event. The heater 10 may therefore partially reduce in temperature or deactivate. The hookah device 2 may then resume the heating stage 122 when the lid 12 is provided in the closed position. Thus, opening of the lid 12 only temporarily pauses the heating cycle.

In general, the device 2 may not operate or initiate if the lid 12 is open (i.e. heating is stopped/prevented). In some embodiments, the device may be configured to shut down if the lid 12 is not returned to the closed position with a predetermined period of time. For example, the predetermined period of time may comprise 1 second preferably: 2 seconds: 5 seconds; or 10 seconds. In some embodiments, the device 3 would then operate in accordance with the remaining time period of the smoking session, as defined by the indicator 40, such that an active smoking session would not exceed the total period defined by indicator 40. An active smoking session is defined as the time period when the device lid 12 is closed and/or the device is not on pause.

Additionally or alternatively, the hookah device 2 is configured monitor the position of the capsule 14. Thus, if the capsule 14 is at least partially removed, the hookah device 2 may initiate the end routine 112 and/or pause event as previously described.

The hookah device 2 continues to heat the capsule 14 in accordance with heating profile 68. When the heating cycle is complete, the hookah device 2 initiates the end routine 112. Heating of the capsule 14 thus stops after a predetermined period of time. This prevents the capsule 14 being overheated (e.g. if the user forgets to deactivate the device) and/or may help to ensure the smoking experience is consistent throughout the heating cycle. The capsule 14 is ejected once the heating cycle in complete. This may help to indicate to the user the capsule 14 should be removed.

The capsule 14 may be ejected once the capsule 14 is sufficiently cooled. The capsule 14 therefore remains in the device 2 after the smoking session to prevent exposure of hot surfaces. In some embodiments, the capsule 14 may be ejected after a predetermined period of time. Additionally or alternatively the capsule 14 is ejected once the capsule 14 reaches a pre-determined. For example, the capsule 14 may be ejected once the capsule 14 and/or heating chamber 10 reaches a temperature less than 100° C.; preferably, less than 75° C.; preferably, less than 50° C. In other embodiments, the capsule may remain in the device at the end of the heating cycle until it is manually removed.

A notification of completion and/or initiation of the end routine 112 may be provided to the user. In some embodiments, the progress of the heating cycle (i.e. the progress through the heating profile) may be provided. The progress indicator may indicate a proportion of the heating cycle passed/remaining and/or a time of the heating cycle passed/remaining. The notification may be continuous/real-time. For example, the notification may indicate 40% of cycle is remaining or 40 minutes of smoking is remaining. The notification may be provided at one or more select points on the progress. The notification may be provided at regular intervals. For example, the notification may be provided every 10% of progress change or every 10 minutes etc. Additionally or alternatively, the notification may be provided at select progress points. For example, the notification may when only 15 minutes of smoking time if remaining. The notification may be provided on the hookah device 2. For example, the hookah device 2 may comprise a progress indicator. Additionally or alternatively, the indicator may be provided on the intermediate device 64. In some embodiments an indicator (e.g. an LED or like) may indicate the heating cycle is close to completion and/or has completed.

Once the end routine is initiated 112 and/or if removal of the capsule 14 during/after the heating stage 122 is detected, then the authentication code of the capsule 14 is recorded by the hookah device 2. As each authentication code is unique, the hookah device 2 records whether an individual capsule 14 has been used (i.e. heated). The authentication code may only be stored if the capsule 14 is exposed to a predetermined temperature (e.g. above the temperature in which the integrity of the smoking product is compromised). For example, the authentication code may only be stored if the capsule 14 is heated to at least 50° C.

In some embodiments, the authentication code may only be stored if the capsule 14 is heated for a predetermined period of time. The predetermined period of time may be time in which the smoking product may be irreversible altered. The predetermined period of time may be a time in which a portion of the smoking product is consumed (i.e. a portion of the total smoking time until the product is depleted). This allows the capsule 14 to be used over a number of sessions. The period of time may be at least 50% of the total smoking time until the product is depleted; preferably, at least 75%; preferably, at least 90%.

The hookah device 2 may store each authenticated code in memory. The authentication code may be sent to a remote database (e.g. via the internet and/or intermediate device 64). During the validation stage 110, the hookah device 2 compares the authentication code of a capsule 14 with the authentication codes of used capsules 14 retained in the memory/database. If the hookah device 2 determines the authentication code of the present capsule 14 matches the authentication code of a used capsule, then the end routine 112 may be initiated. The hookah device 2 therefore determines whether a given capsule 14 has been previously heated in the hookah device 2 and selectively prevents heating the capsule 14 if such a condition is met. Conversely, if the hookah device 2 determines the authentication code of the present capsule 14 does not correspond to the authentication code of a used capsule 14, the heating cycle is initiated. This prevents heating of an empty, aged and/or recycled capsule 14.

In some embodiments, the indicator 40 is configured to be destroyed or otherwise rendered inoperable during heating thereof. For example, the indicator 40 may destroyed upon reaching a temperature of at least 60° C.; preferably, at least 80° C.; preferably, at least 100° C. The indicator 40 may be configured to melt, combust, decompose, pyrolyze, vaporise and/or otherwise change form/phase. The indicator 40 may be configured to be destroyed due to the intrinsic properties thereof. For example, the heating temperature is above the melting/combustion temperature of the indicator 40 and/or critical components thereof. Additionally or alternatively, the indicator 40 may comprise a predetermined point of failure configured to be destroyed at a predetermined temperature. For example, the indicator 40 may comprise a fuse configured to melt/combust during heating, thus rendering the indicator 40 in operatable. If the indicator 40 is destroyed, upon re-insertion into the hookah device 2, the reading step 108 and/or the integrity step 110 will fail, thereby preventing re-use of the capsule 14. In some embodiments, indicator 40 may be physically or partially destroyed through the removal of the indicator from capsule 14. For example, the indicator 40 may be configured to delaminate upon removal and/or may be frangible.

In some embodiments, the hookah device 2 and/or mobile device 64 is configured to initiate a “kill” routine. The kill routine is configured to render the indicator 40 at least partially inoperable to prevent re-use thereof. In some embodiments, the device 2 may configured to erase at least a portion of the memory of the indicator 30. The device 2 may delete any portion of the indicator 30 memory required for successful operation during the integrity check step 110 discussed above. In some embodiment, the device 2 may write a flag or other signal to the indicator 30 memory to indicate the capsule has been used/invalid.

In some embodiments, the indicator 30 is configured to delete at least a portion of the memory thereof upon reception of a code or signal. For example, the hookah device 2 and/or mobile device 64 may be configured to transmit a “kill” signal or code. Upon reception of the code, the indicator 30 deletes all or a least a portion of the indicator memory. The indicator 30 may delete any select portion of the memory to prevent use thereof, as previously described. The code or signal may comprise a unique code or signal recognised by the indicator 30.

Referring now to FIG. 30, the memory 128 on the indicator 30 is operatively divided into two portions. A first portion 130 provides a “public” memory portion. The public portion 130 is accessible without authentication. The public portion 130 may therefore be accessible by any device suitable to interrogate the indicator 30. For example, the mobile device 64 may read/interrogate the public portion 130 of the memory.

A second portion 132 provides a “private” portion. The private portion 132 is only accessible via authentication. The authentication may be provided as previously described. Only authenticated devices may therefore access the private memory 132. This ensures that only specific devices may access the private portion, thus ensuring data integrity.

The public portion 130 may comprise generic or public data. For example, an ID or name/flavour ID for the capsule 14 may be located in the public portion 130. This allows any device to identify the contents of the capsule 14. Conversely, the private portion 132 contains private or propriety data, and thus should only be read by authorised devices. For example, the private portion 132 contains one or more heating profile 68, manufacturing data and/or personal data (i.e. data that may be subject to privacy regulations).

The public portion 130 may be re-writable memory. The user may therefore be able to write data to the public portion 130. The user may be able to specify their usage condition and record the usage condition in the public portion 130. For example, the user may use the mobile device 64 to record their desired intensity on the capsule memory 128. The hookah device 128 may then read the user preference and select the appropriate heating profile accordingly. The user may record the number of users, or other user preferences.

The public portion 130 may record usage data of the capsule 14. The usage data may include the time the capsule 14 has been heated; the time remaining before the product is depleted; or a proportion of the product 30 consumed. This can provide an indication to the user how much of smoking product 30 is remaining. The usage data may be read by the hookah device 2, thereby allowing continuation of a previous heating session (i.e. the heat profile 68 is resumed). The capsule 14 thus acts as an intermediate to facilitate communication between the hookah device 2 and the mobile device 64.

In some embodiments, the data on the indicator 40 (i.e. the public and/or private portion thereof) may be rewritable. For example, the hookah device 2 may format the data on the indicator and/or add a read count (i.e. the number of times the hookah device has read/interrogated the memory).

The smoking product 30 may comprise any suitable form or composition. The smoking product comprises a “mist-maker”. The mist-maker is configured to create a cloud when vapourised. The mist-maker comprises a volatile material configured to provide a light-scattering cloud in a vaporised state. The mist-maker comprises a polyol. The polyol may comprises one of more of: glycerin; 1,2-propylene glycol; 1.3-propylene glycol; 1,2-butylene glycol; 1,3-butylene glycol; 1,4-butylene glycol; 2,3-butylene glycol; 1,2,4-butanetriol; triethylene glycol; triacetin; mannitol; sorbitol; xylitol; inositol; isosorbide; polydextrose; or dianhydro-D-glucitol. The polyol may comprise a “sugar alcohol” (hydrogenated sugar).

The product may comprise a sweetener. The sweetener may comprise carbohydrate sweeteners (e.g. monosaccharides of 5 or 6 carbon atoms), for example, one or more of: arabinose; xylose; ribose; glucose; mannose; galactose, fructose; dextrose; or sorbose. The sweetener may comprise disaccharides, for example, one or more of: sucrose, such as cane or beet sugar; lactose; maltose; or cellobiose. The sweetener may comprise polysaccharides, for example, one or more of: partially hydrolyzed starch or dextrin; polyols, such as sorbitol, mannitol, xylitol; and mixtures with one or more of the above sugars. The sweetener may comprise a complex sugar/carbohydrate mixture (e.g. a natural sugar product). The sweetener may comprise one or more: molasses; invert syrup; corn (maize) syrup; maple syrup; golden syrup; treacle etc.

In some embodiments, the sweetener comprises high-fructose corn syrup (also known as glucose-fructose isoglucose and glucose-fructose syrup).

In some embodiments, the sweeteners comprise artificial sweeteners. The artificial sweeteners may comprise one or more of: sodium, calcium or ammonium saccharin salts; dihydrochalcones; rebaudiosides; mogrosides; glycyrrhizin; dipotassium glycyrrhizin; glycyrrhizic acid ammonium salt; L-aspartyl-L-phenylalanine methyl ester (aspartame); the sodium or potassium salt of 3,4-dihydro-6-methyl-1,2,3-oxathiazine-4-one-2,2-dioxide (Acesulfame-K); extracts of Stevia rebaudiana (Stevioside); extracts of Richardella dulcifica (Miracle Berry); orextracts of Dioscoreophyllum cumminsii (Serendipity Berry).

It can be appreciated that any of the above sweeteners may be combined with any of the other above sweeteners or classes of sweeteners.

The product comprises a flavouring. The flavouring may comprise, inter alia, one or more of: mint; such as peppermint and spearmint; chocolate; liquorice; citrus and other fruit flavours; gamma octalactone; vanillin; ethyl vanillin; or breath freshener flavours. The above-described sweeteners may comprise an example of a flavouring but typically both a sweetener and a further flavouring are provided.

The flavouring may comprise spice flavours, for example, one or more of: cinnamon; methyl salicylate; linalool; bergamot oil; geranium oil; lemon oil; or ginger oil. The flavouring may comprise plant extracts or essential oils. The flavouring may comprise a food-based flavouring, for example, one or of: apple flavouring; blueberry flavouring; coconut flavouring; grape flavouring; guava flavouring; pomegranate flavouring; or lemon flavouring etc. The flavouring may comprise a fruit or plant flavour. The flavouring may comprise one or more of: an acid; an alcohol; an ester; an aldehyde; a ketone; or a pyrazine.

The product, e.g. the flavouring thereof, may comprise a stimulant. The stimulant has a stimulatory effect on the central nervous system and may induce alertness in a subject. The stimulant may comprise one or more: caffeine (1,3,7-trimethylxanthine); taurine (2-aminoethanesulfonic acid); theobromine (3,7-dimethylxanthine); or their derivatives.

In some embodiments, the stimulant is provided by a plant-based extract forming part of the flavouring. The plant extract may comprise one or more of: coffee; black tea; green tea; matcha; mate; kola nut; cocoa; ginseng; guarana; or a cannabinoid such as tetrahydrocannabinol (THC) or cannabidiol (CBD). In other embodiments, the stimulant may comprise an additive provided in addition to the flavouring. For example, a coffee flavouring may be enhanced with additional caffeine.

The product may comprise a colourant. The colourant may provide a coloured product 30 and/or smoke. The colourant comprises a food, pharmaceutical or cosmetic safe colourant. The colourant comprises a water-soluble colourant. The colourant comprises a plant based colourant, for example, one or more of: beet juice; brazilwood; caramel; carminic acid; litmus; logwood; orchil; or saffron. In some embodiments, the colourant comprises an artificial colourant.

In a specific embodiment, the smoking product comprises a shisha or Mu'assel. The shisha comprises tobacco. The tobacco may be shredded or otherwise particulated. The tobacco is mixed with a sweetener (e.g. molasses) and a mist-maker (e.g. glyercol). The shisha is thus provided as a viscous, semi-solid. In some embodiments, the shisha may be tobacco free. The shisha may comprise a nicotine additive and/or substitute. The shisha may comprise a tobacco substitute. The tobacco substitute may comprise an organic substate. In some examples, the smoking product may comprise other substances derived from marijuana, cannabis or hemp, e.g. in addition to, or instead of tobacco or tobacco substitute products.

In some embodiments, the smoking product may be provided on an inert substrate. The substrate comprises an inert or food safe material. The inert material is configured to not to melt, combust, decompose or otherwise deteriorate when exposed to heat. For example, the inert material is temperature stable to at least 200° C.; at least 300° C.; or at least 300° C.

The inert substrate may comprise an inorganic or mineral material. In some embodiments, the inert material comprises a non-crystalline amorphous material, such as glass. The glass may comprise a silica (SiO2) based glass. The glass may comprise one or more of:

fused quartz (also known as fused-silica or vitreous silica); soda-lime-silica glass; sodium borosilicate glass; lead-oxide glass; foamed glass; or aluminosilicate glass.

In some embodiments, the inert material comprises a mineral. For example, the mineral may comprise one or more of: silica; limestone (calcium carbonate); feldspar (tectosilicate minerals); gypsum; magnetite (Fe3O4); chlorite ((Mg,Fe)3(Si,Al)4O10(OH)2·(Mg,Fe)3(OH)6); glauconite ((K,Na)(Fe3+,Al,Mg)2(Si,Al)4O10(OH)2); or alumina.

In some embodiments, the inert material comprises a stone/rock material (i.e. a natural substance containing one or more minerals or mineraloids). For example, the stone material may comprise one or more of: granite; basalt; marble; quartz; pumice; obsidian; jet; biotite; or the like. In some embodiments, the inert material may comprise a ceramic. The ceramic may be semi-crystalline, vitrified or amorphous. The ceramic may be clay and/or alumina based. In some embodiments, the inert materials comprises one or more of: activated carbon powder; graphite powder; graphene; carbon fibre or the like. In some embodiments, the inert material may comprise an agglomeration or composite of one or more inert material. For example, inert material may comprise a cementitious material or mixture of liquid phase and solid phase (e.g. granular) materials.

In some embodiments, the inert filler may comprise a sand or granules (e.g. a crushed or fine particulate). The sand may comprise particles of one or more of the above materials. The average particle size of the granules is such that the filler has a grainy/sandy consistency and does not form suspensions in the air in the manner of finer particulates such as powders and dust. This may reduce the health risks associated with fine powders. In a specific embodiment, the substate comprises: stone; glass; ceramic; pumice or sand. The product may be provided on the surface of the substrate (e.g. provides a coating on the substrate). The substrate may there provide a core. The coating may cover substantially the whole surface of the substrate, thus maximising the surface area of the product. The coating may comprise a uniform thickness across the surface of substrate.

The substrate may comprise rounded/spherical shape. The product and the substrate thus define a bead like arrangement.

In some embodiments, the smoking product may be provided as plurality of particles. The particles may be granular and/or powdery. The particles may be sticky or otherwise prone to agglomeration.

In a specific embodiment, a shisha product is provided with a substrate. The substrate may comprise the inert material as previously described. The substrate comprises a particulate (e.g. a bead or the like). The beads are aligned to form a layer arrangement. In some embodiments, the substrate may comprise a smoking product. The smoking product may be provided as a coating and/or layer on the substrate.

The shisha product may be compacted onto the substrate. The substrate is therefore at least partially embedded within the shisha product. The shisha product may fill at least some of the space between the beads and/or the beads and the capsule 14. The substrate may provide a partial barrier and/or buffer between the shisha product and the capsule wall. In other embodiments, the shisha product may completely envelope the substrate.

In some embodiments, the smoking product 30 directly deposited into the heating chamber 10. Thus, the smoking product 30 is not contained with a capsule 14 or the like. It can be appreciated that a heating profile 68 may still be provided for the smoking product 30. For example, the smoking product 30 may comprise an indicator 40 on the packaging thereof. Similarly, the indicator 30 may provided any suitable information on the smoking product 30 as previously described.

In some embodiments, the capsule 14 may be used to contain a product not typically used for smoking. The product contained a product that may be configured to be heated. Thus, the capsule 14 may provide a heating profile 68 for the product. The product may comprise a beverage or precursor for manufacture thereof, for example, one or more of: coffee; tea; hot chocolate; soft drinks (e.g. syrup) or the like. The product may comprise mixed beverage composition, for example, one or more of: espresso; latte; cappuccino; mocha etc.

The present arrangement allows a hookah device to heat a smoking product according to a heating profile. This allows complex variation in the heating temperature of the smoking product, thereby providing an optimal smoking experience for the user. The profile may be provided in a simple and data efficient manner. The profile may ensure that the heater is deactivated once the product is depleted and/or a smoking session is completed.

The indicator allows determination of the authenticity of the smoking product and/or the integrity thereof. The indicator may provide an indicator the smoking product has been exposed to excessive temperatures. The indicator may provide further information relating to the smoking product, thereby allowing the hookah device to adapt the operation thereof in accordance with the smoking product. For example, the indicator allows the hookah device to automatically determine a heating profile for the smoking product.

The heating cycle routine ensures the heater is not activated when a capsule is not provided and/or when the lid is open. This increases the safety of the device. The hookah device may be easily updated to provide improved software facilities.

1. A capsule for use with an electronically heated water pipe device, the capsule comprising:
a cavity having a consumable product therein to be released by heating in use; and
a machine readable or interrogable indicator, the indicator comprising data instructions for a heating temperature or profile of the consumable product and data relating to the product comprising a unique code for authenticating the capsule, wherein the unique code is encrypted or provided in a private memory of the capsule.

2. The capsule according to claim 1, where the heating profile is a transient heating profile and comprises a plurality of individual data points relating to different heating temperatures or power values and respective times or time periods for said data points such that a point of application of said different heating temperatures or power values is spaced in time.

3. The capsule according to claim 1, where the indicator comprises an electronically readable/interrogable memory device, and the heating profile is stored on the memory device.

4. The capsule according to claim 3, where the indicator comprises a wireless communication interface to provide reading/interrogation thereof, and the heating profile data is retrievable via the wireless communication interface.

5. The capsule according to claim 1, where the capsule comprises an outwardly extending rim, and the indicator is provided on or adjacent the rim.

6. The capsule according to claim 1, where the indicator is provided on a carrier removably mounted to the capsule, the carrier comprising a temperature resistant polymeric material.

7. (canceled)

8. The capsule according to claim 6, where the carrier comprises a collar or sleeve configured to engage and at least partially surround the capsule.

9. The capsule according to claim 6, where the indicator is at least partially embedded within the carrier and the carrier comprises an outwardly extending tab, and the indicator is provided on the tab.

10. (canceled)

11. (canceled)

12. The capsule according to claim 1, where the indicator comprises one or more of: a barcode; a QR code; a 2-dimensional code; a coloured portion; or a plurality of coloured portions.

13. (canceled)

14. The capsule according to claim 1, where indicator further comprises data indicative of one or more of: a batch number; manufacturing date/time;
expiry date; use-by date; ingredients; allergens; and or weight/volume of the consumable product.

15. The capsule according to claim 1, where the indicator comprises a checksum for the data comprised therein.

16. The capsule according to claim 1, where the indicator is only readable or interrogable if a predetermined code or authentication token or cipher is provided.

17. The capsule according to claim 1, where the indicator comprises electronic memory, the memory comprising both a public memory portion and the private memory, the private memory only being accessible via authentication.

18. The capsule according to claim 17, where the public memory portion is rewritable.

19. The capsule according to claim 17, where the heating profile data is stored in the private memory portion.

20. The capsule according to claim 1, where the consumable product comprises a vapourisable product.

21. An electronically heated water pipe comprising:
a heating chamber configured to receive a capsule comprising a cavity to contain a consumable product; and
at least one sensor configured to electronically read or interrogate an indicator provided on the capsule and extract data comprising: a unique code for authenticating the capsule, wherein the unique code is encrypted or provided in a private memory of the capsule; and, instructions relating to a heating profile of the smoking product; and
a controller configured to determine if the unique code extracted from the indicator corresponds to unique code provided in a predefined list of codes and selectively control the temperature of the heating chamber in accordance with said determination and the heating profile.

22. The electronically heated water pipe according to claim 21, where the sensor comprises a wireless communication interface on or adjacent the heating chamber.

23. The electronically heated water pipe according to claim 21, where the heating chamber comprises an opening to receive the capsule and the sensor is provided adjacent the opening of the heating chamber.

24. (canceled).

25. (canceled).

26. The electronically heated water pipe according to claim 21, where the water pipe is operatively connected to an intermediate computing device, and the sensor is provided on the intermediate computing device.

27. The electronically heated water pipe according to claim 21, where the water pipe device is configured to heat the indicator to a predetermine temperature to destroy or disable the indicator.

28. The electronically heated water pipe according to claim 21, where the controller is devoid of machine-readable code for controlling a transient heating profile until the extracted data instructions relating to the heating profile of the consumable product are received from the capsule.

29. (canceled)

30. (canceled)

31. (canceled)

32. The electronically heated water pipe according to claim 21, where the controller is configured to record the unique code in the predefined list during or after heating of the capsule in the heating chamber once the capsule has been heated to a predetermined temperature and the controller selectively denies heating of the capsule in the heating chamber if the unique code of the extracted data corresponds to a unique code provided in the predefined list of codes that have been heated.

33. The electronically heated water pipe according to claim 21, where the controller is configured to transmit a predetermined authentication code/token/cipher to the indicator to access the private memory portion thereof in use.

34. The electronically heated water pipe according to claim 21, where the water pipe is operatively connected to an intermediate device, wherein the intermediate device comprises a user interface for selecting or modifying a heating profile for the capsule, the controller configured to receive data from the intermediate device for implementing the selected or modified heating profile.

35. (canceled)
